(19) United States
(12) Patent Application Publication
(10) Pub. No.: US 2025/0322383 A1
(43) Pub. Date: Oct. 16, 2025

(54) SECURE INTERFACE

(71) Applicant: Capital One Services, LLC, McLean, VA (US)

(72) Inventors: Tyler MAIMAN, Melville, NY (US); Michael MOSSOBA, Arlington, VA (US); Joshua EDWARDS, Philadelphia, PA (US)

(21) Appl. No.: 18/631,199

(22) Filed: Apr. 10, 2024

(51) Int. Cl. G06Q 20/34; G06K 19/07; G06Q 20/32

(52) U.S. Cl. CPC G06Q 20/341; G06K 19/0723; G06Q 20/3278

(57) ABSTRACT

A method, a system, and a computer program product for providing a secure interface for execution of transactions. An audio signal receiving device detects and establishes a near-field communication (NFC) exchange communication link with a first device. The receiving device receives one or more signals from the first device. Each signal is responsive to one or more transmissions sent to the first device by a transceiver coil of the receiving device. Based on a determined signal strength of signals, the receiving device determines a first position of the first device in relation to the receiving device and generates one or more prompts to reposition the first device in relation to the receiving device from the first position to one or more second positions. At least one second position corresponds to a maximum signal strength of signals. The receiving device then extracts information from the first device.

### TECHNICAL FIELD

This disclosure relates generally to data processing and, in particular, to contactless cards, and more particularly, to providing a secure interface for execution of transactions.

### BACKGROUND

Tap-to-pay transactions have become some of the most popular ways of paying for goods and services. Tap-to-pay is based on radio-frequency identification (RFID) technology that may be embedded into credit cards, smartphones, and other mobile devices. This technology allows users to make credit card transactions by bringing their cards and/or smartphones within a specific distance of (or tapping on) specific areas of point-of-sale terminals, which enables transfer of certain data for the purposes of making a payment. Prior to employing tap-to-pay features, the devices, cards, etc. having such capability typically must be appropriately activated. However, existing contactless card environments do not use audio signal receiving devices for execution of various transactions.

### SUMMARY

A computer-implemented method for providing a secure interface for execution of transactions. The method may include detecting, using at least one processor of an audio signal receiving device, a first device and establishing a near-field communication (NFC) exchange communication link with the first device, and receiving one or more signals from the first device. Each of one or more signals may be responsive to one or more transmissions generated and sent to the first device by a transceiver coil of the audio signal receiving device. The transceiver coil may be coupled to the at least one processor. The method may also include determining a signal strength of one or more signals from the first device, and, based on the determined signal strength, determining a first position of the first device in relation to the audio signal receiving device. The method may further include generating one or more prompts to reposition the first device in relation to the audio signal receiving device from the first position to one or more second positions. At least one second position in one or more second positions may correspond to a maximum signal strength of the one or more signals. The processor of the audio signal receiving device may then extract information from the first device upon the first device being in the second position.

In some implementations, the current subject matter may include one or more of the following optional features. The audio signal receiving device may include at least one of: one or more earphones, one or more headphones, one or more virtual reality devices, one or more augmented reality devices, one or more virtual reality glasses, one or more augmented reality glasses, and any combinations thereof.

In some implementations, the first device may be a contactless card. The contactless card, based on the establishing of the NFC exchange communication link, may be configured to transmit to the audio signal receiving device a contactless card data. The contactless card data may include at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof. The contactless card may include at least one of the following: a credit card, a debit card, an electronic gift card, a pre-paid credit card, a pre-paid debit card, and any combination thereof.

In some implementations, the signal strength may be determined based on a current load measured at the transceiver coil. The maximum signal strength may correspond to a maximum current load measured at the transceiver coil.

In some implementations, a content of at least one prompt in one or more prompts may be different from at least another prompt in one or more prompts and may be determined based on the determined signal strength. The content of at least one prompt may include at least one of: an audio prompt, a video prompt, a graphics prompt, an image prompt, a textual prompt, and any combinations thereof.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A illustrates an exemplary system for executing various operations and/or transactions using an audio signal receiving device and a contactless card, according to some implementations of the current subject matter;

FIG. 1B illustrates the system of FIG. 1A where the contactless card has been repositioned in relation to the audio signal receiving device, according to some implementations of the current subject matter;

FIG. 2 illustrates further details of the audio signal receiving device, according to some implementations of the current subject matter;

FIG. 3 illustrates an example of a processing system, according to some implementations of the current subject matter;

FIG. 4 illustrates an example process for positioning and/or repositioning of a contactless card with respect to an audio signal receiving device, according to some implementations of the current subject matter;

FIG. 5 illustrates an example process for using an audio signal receiving device for transmission of information from a contactless card to a computing device, according to some implementations of the current subject matter;

FIG. 6 illustrates a data transmission system, according to some implementations of the current subject matter;

FIG. 7 illustrates a data transmission system, according to some implementations of the current subject matter;

FIG. 8A illustrates a contactless card, according to some implementations of the current subject matter;

FIG. 8B illustrates a transaction card component, according to some implementations of the current subject matter;

FIG. 9 illustrates a sequence flow, according to some implementations of the current subject matter;

FIG. 10 illustrates a data structure, according to some implementations of the current subject matter;

FIG. 11 is a diagram of a key system, according to some implementations of the current subject matter;

FIG. 12 is a flowchart of a method of generating a cryptogram, according to some implementations of the current subject matter;

FIG. 13 depicts an exemplary process illustrating key diversification, according to some implementations of the current subject matter;

FIG. 14 illustrates a method for card activation, according to some implementations of the current subject matter;

FIG. 15 illustrates an example of a system, according to some implementations of the current subject matter;

FIG. 16 illustrates an example flow to perform card key derivation, according to some implementations of the current subject matter;

FIG. 17 illustrates an aspect of the subject matter in accordance with one embodiment;

FIG. 18 illustrates an aspect of the subject matter in accordance with one embodiment;

FIG. 19 illustrates an aspect of the subject matter in accordance with one embodiment;

FIG. 20 illustrates an aspect of the subject matter in accordance with one embodiment;

FIG. 21 illustrates an aspect of the subject matter in accordance with one embodiment;

FIG. 22 illustrates an example of a process, according to some implementations of the current subject matter;

FIG. 23 illustrates an aspect of the subject matter in accordance with one embodiment;

FIG. 24 illustrates an aspect of the subject matter in accordance with one embodiment; and

FIG. 25 illustrates a computer architecture, according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide an ability to assist and/or expedite execution of transactions involving contactless cards using audio signal receiving devices and/or applications and/or any other devices.

In some implementations, the current subject matter generally relates to an ability to use a contactless card and an audio signal receiving device to execute one or more transactions (e.g., payment transactions, etc.), where the contactless card may be guided through a series of prompts to be repositioned and/or repositioned with respect to the audio signal receiving device for transmission of contactless card data. For example, a user may be shopping online (e.g., using a merchant's website) and would like to make a purchase using user's contactless card. Rather than entering the card's information (e.g., contactless card number, expiration date, etc.) into the website of the merchant and, in some situations, potentially exposing it to theft, the user may position proximate to and/or tap the contactless card to user's audio signal receiving device (e.g., earphones, headphones, virtual reality devices, augmented reality devices, virtual reality glasses, augmented reality glasses, etc., and any combinations thereof). Once positioned/tapped, the circuits in the contactless card may be energized by the audio signal receiving device, which may trigger transmission of contactless card data by the contactless card to the audio signal receiving device, which may, in turn, transmit the contactless card data to the user's mobile device for completion of the purchase transaction. In some implementations, the audio signal receiving device may also announce to the user, at least a portion of the contactless card data (e.g., last four digits of the contactless card, expiration date, etc.) that it received from the contactless card and may prompt the user to verify the data using the user's mobile device, which may communicate with the audio signal receiving device. The user may use the audio signal receiving device to provide authentication information (e.g., confirm user's identity, contactless card's information, etc.). Once the information is verified, the transaction may be executed.

To ensure that the contactless card can transmit its data to the audio signal receiving device, the audio signal receiving device may be configured to guide the user, e.g., through a series of prompts, to position and/or reposition the contactless card proximate to the audio signal receiving device. The guiding by the audio signal receiving device may be accomplished through use of near-field communication (NFC) exchange communication protocols. For instance, the audio signal receiving device may be configured to detect the contactless card to be located within a predetermined boundary and/or area and/or distance from the audio signal receiving device. Once the audio signal receiving device detected the contactless card, the audio signal receiving device may be configured to establish an NFC exchange communication link with the contactless card.

Establishment of the NFC exchange communication link may enable one or more circuits of the contactless card to be energized for transmission of data to the audio signal receiving device. In this case, the audio signal receiving device may be configured to act as an “active” component and provide power to energize the contactless card, which may be considered as a “passive” component. Once the circuits in the contactless card are energized, the contactless card may be configured to transmit data using one or more signals containing data packets to the audio signal receiving device. The transmitted data may be stored in the contactless card memory. The audio signal receiving device may be configured to receive the signals from the contactless card. The contactless card may be configured to send signals to the audio signal receiving device in response to establishing of the NFC exchange communication link and/or in response to a request transmitted from the audio signal receiving device to the contactless card. The request may be generated by the process of the audio signal receiving device and transmitted to the contactless card by a transceiver coil of the audio signal receiving device.

As stated above, in some implementations, upon detecting the contactless card within a predetermined distance, area, boundary, etc. of the audio signal receiving device, the audio signal receiving device may request and/or be automatically provided with various data, including identification data, contactless card data, etc., from the contactless card. The card's identification data may include various information identifying the card and/or the user of the card. It may include one or more identifiers that may be used to identify the card. The contactless card data may include the contactless card data includes at least one of the following: an account number associated with the contactless card, an expiration date associated with the contactless card, a card verification value (CVV) associated with the contactless card, a billing address associated with the contactless card, a name of a user associated with the contactless card, and any combination thereof. In some implementations, the audio signal receiving device may be configured to store (e.g., temporarily) the received contactless card data and/or transmit it to one or more mobile devices, servers (e.g., servers that may be communicatively coupled to the mobile device and associated with the financial institution that issued the card).

The mobile device, in response to receiving contactless card data from the audio signal receiving device, may use the contactless card data to generate one or more user interfaces (e.g., applets) that may display user's various financial accounts, request confirmation from the user to authorized and/or cancel/deny a transaction, and/or perform any other action. The mobile device may also use the contactless card data to retrieve user's financial accounts information from various financial institutions and then display them in the generated user interface.

In some implementations, the audio signal receiving device may be configured to determine a signal strength and/or strengths of one or more signals transmitted from the contactless card. The signal strength(s) may be used to assess location of the contactless card in relation to the audio signal receiving device. For example, the audio signal receiving device may include one or more sensors that may detect signal strength(s) (e.g., signal strength may be determined based on a current load measured at the transceiver coil, current values, voltage values, resistance values, etc.) and provide this information to the processor of the audio signal receiving device to ascertain signal strength of signals received from the contactless card. In some example implementations, the current subject matter, for the purposes of signal strength determination, may use one or more radio frequency (RF) detectors together with the transceiver coil, which may be implemented in a diode, capacitor, divider, etc. circuitry. As can be understood, any other type of sensors may be used to determine signal strengths.

Upon analyzing signals strength(s), the audio signal receiving device may be configured to determine a location or a position of the contactless card with respect to the audio signal receiving device. For example, the audio signal receiving device may determine that the contactless card is positioned too far (e.g., corresponding to a weak signal, which in turn, may correspond to a low current in the transceiver coil) for a reliable transmission of data between the contactless card and the audio signal receiving device and/or for establishment of a reliable NFC exchange communication interface. If the audio signal receiving device determined that the contactless card is located too far from the audio signal receiving device, the audio signal receiving device may generate one or more prompts, e.g., audio prompts, etc., which the user may hear and/or observe. The prompts may request the user to reposition the contactless card in relation to the audio signal receiving device from the initial position of the contactless card to one or more other positions, where such positions may be determined by the audio signal receiving device as corresponding to a maximum signal strength of the signals being received from contactless card. For example, the maximum signal strength may be determined by comparing the strengths of signals received from the contactless card to one or more predetermined threshold signal strengths (e.g., the maximum signal strength may correspond to a maximum current load measured at the transceiver coil).

In some implementations, contents of each prompt generated by the audio signal receiving device 102 may be different and may be determined based on the determined signal strength. For example, the prompts may have different tones, e.g., when the contactless card is located to far, the tone may be a buzzer tone and when the contactless card is located at a location corresponding to the maximum signal strength, the tone may be a ding tone. As can be understood, any other types of prompts may be used and may include at least one of: an audio prompt, a video prompt, a graphics prompt, an image prompt, a textual prompt, and any combinations thereof.

Once the contactless card is located at a position with respect to the audio signal receiving device that corresponds to a maximum signal strength, the audio signal receiving device may be configured to extract information, contactless card data, etc. from the contactless card. As stated herein, the contactless card data may be transmitted via the NFC exchange communication link and may include at least of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof. Further, any type of contactless card may be used, including, for example, but not limited to, at least one of the following: a credit card, a debit card, an electronic gift card, a pre-paid credit card, a pre-paid debit card, and any combination thereof.

In some implementations, the current subject matter relates to a method for transmission of contactless card data from a contactless card to an audio signal receiving device for the purposes of executing a transaction (e.g., a sales transaction, an authentication transaction, a verification transaction, etc.). The method may be executed using a system that may use the audio signal receiving device that may serve as an intermediary between the contactless card and a computing device (e.g., a mobile device, a sales terminal, and/or any other computing device). The contactless card and the audio signal receiving device may communicate with one another using an NFC exchange communication link and/or any other wireless communication link. The contactless card and the computing device may communicate with one another using another wireless communication link (e.g., BLUETOOTH, WIFI, etc.).

The audio signal receiving device may be configured to receive one or more signals from the contactless card via a wireless communication link communicatively established between the contactless card and the audio signal receiving device. As stated above, the wireless communication link communicatively coupling the contactless card and the audio signal receiving device may include an NFC exchange communication link and/or any other type of link. The audio signal receiving device may include one or more processors and/or a memory along with a transceiver coil, an antenna (as well as other audio signal processing components, including, but not limited to, speaker, a microphone, etc.). As discussed herein, the contactless card may be configured to transmit signals to the audio signal receiving device upon being detected by the audio signal receiving device to be within a predetermined boundary surrounding the audio signal receiving device. The audio signal receiving device, upon detecting the contactless card, may be configured to transmit one or more signals that may energize circuits of the contactless card and cause it to transmit signals containing contactless card data to the audio signal receiving device.

Once the contactless card data signals are received from the contactless card, the audio signal receiving device may be configured to convert these signals to signals for transmission to the computing device that may be communicatively coupled to the audio signal receiving device using another communication link (e.g., a BLUETOOTH, WIFI, etc.). Conversion of the contactless card data signals by the audio signal receiving device may involve extraction of information or data associated with the contactless card from one or more data packets contained in the contactless card data signals and generation of one or more data packets for transmission to the computing device based on the extracted information/data associated with the contactless card. The audio signal receiving device may then use the generated data packets to generate one or more signals for transmission to the computing device.

The audio signal receiving device may then transmit the generated signals to the computing device using wireless communication link communicatively coupling the audio signal receiving device and the computing device. As can be understood, the respective wireless communication links communicatively coupling the contactless card, the audio signal receiving device, and the computing device may be the same and/or different. Upon receiving the generated signals from the audio signal receiving device, the computing device may generate one or more graphical user interfaces based on the received signals. For example, the graphical user interfaces may display the information/data associated with the contactless card. The information/data associated with the contactless card and that may be displayed in the graphical user interface may include at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

With general reference to notations and nomenclature used herein, the detailed descriptions herein may be presented in terms of program procedures executed on a computer or network of computers. These procedural descriptions and representations are used by those skilled in the art to effectively convey the substance of their work to others skilled in the art.

In some instances, contactless card functions discussed herein may be utilized in a multi-issuer computing environment. These functions may include tap-to functions where a user may tap their contactless card on a device, such as a mobile device, to perform a function. For example, a user may utilize their contactless card to verify their identify, perform a payment, launch applications, login into applications, autofill a form or field, navigate to a specified web location or app on a device, unlock a door, initiate a contactless card, verify themselves, and so forth.

The systems discussed here may enable users to perform these functions in a multi-issuer environment. Further, the systems discussed herein enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed herein enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer cannot access another issuer's data or functions. As will be discussed in more detail, these features may be provided by a switchboard system that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS®platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact. The term “coupled,” however, may also mean that two or more elements are not in direct contact with each other, but yet still cooperate or interact with each other.

Various embodiments also relate to apparatus or systems for performing these operations. This apparatus may be specially constructed for the required purpose, or it may include a computer as selectively activated or reconfigured by a computer program stored in the computer. The procedures presented herein are not inherently related to a particular computer or other apparatus. Various machines may be used with programs written in accordance with the teachings herein, or it may prove convenient to construct more specialized apparatus to perform the required method steps. The required structure for various machines will appear from the description given.

In the figures and the accompanying description, the designations “a” and “b” and “c” (and similar designators) are intended to be variables representing any positive integer. Thus, for example, if an implementation sets a value for a=5, then a complete set of components 123 illustrated as components 123-1 through 123-a (or 123a) may include components 123-1, 123-2, 123-3, 123-4, and 123-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

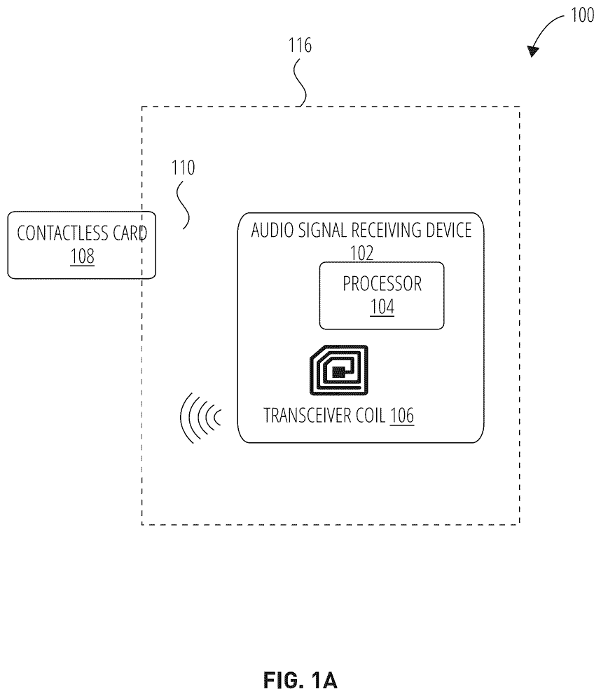

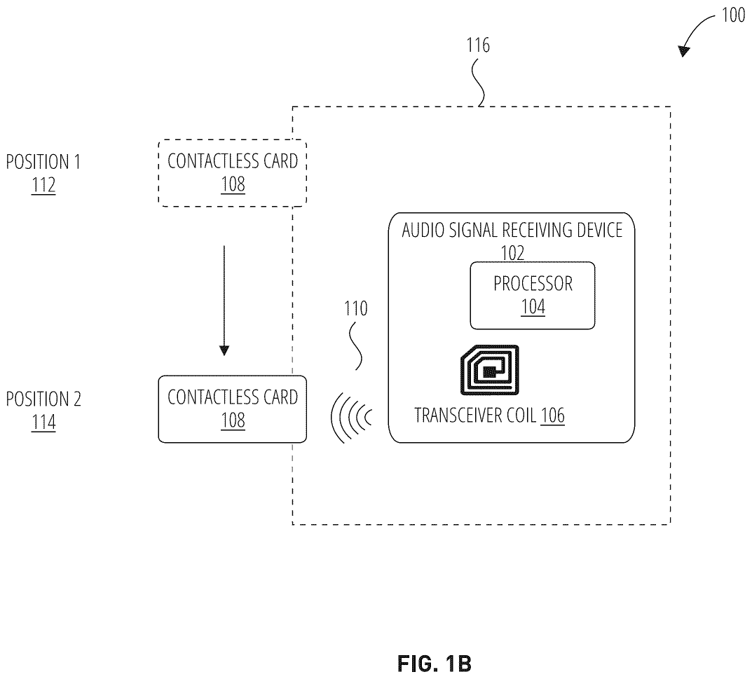

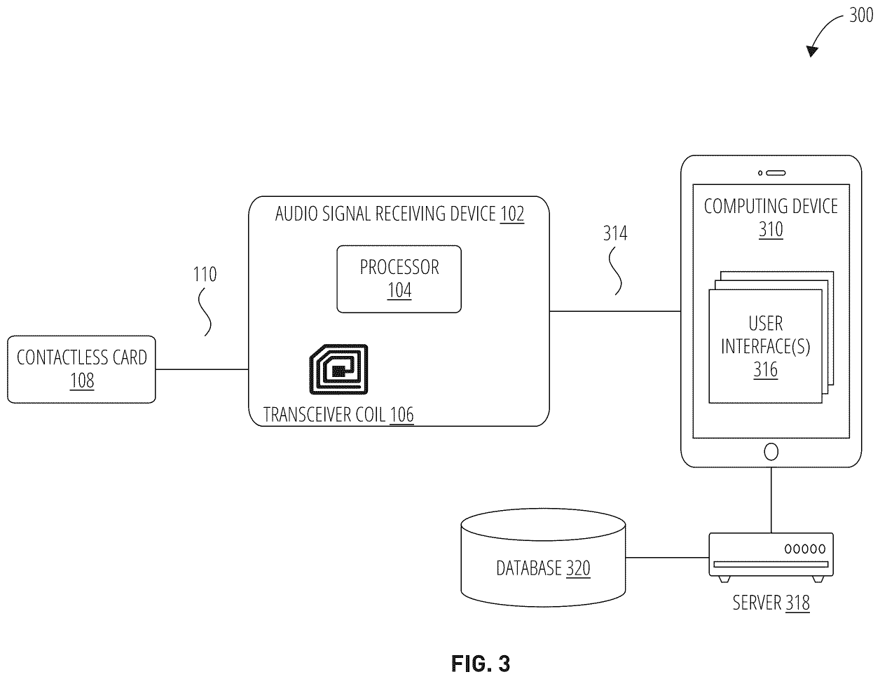

FIG. 1A illustrates an exemplary system 100 for executing various operations and/or transactions using an audio signal receiving device and a contactless card, according to some implementations of the current subject matter. The system 100 may include an audio signal receiving device 102 (among other electronic components (e.g., audio signal processing components, memory, etc.) having a processor 104 and a transceiver coil 106, and a contactless card 108. The system 100 may also include one or more computing devices (e.g., computing device 310, as shown in FIG. 3), a server (e.g., server 318, as shown in FIG. 3), and a database (e.g., database 320, as shown in FIG. 3).

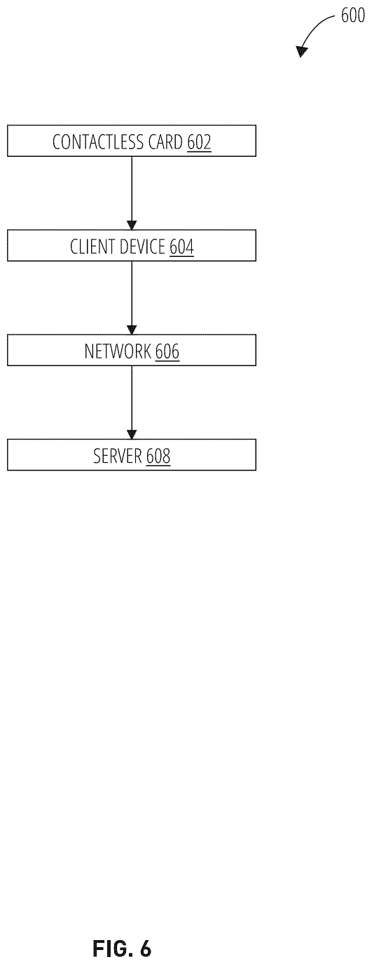

The contactless card 108 may have one or more features discussed herein in connection with FIGS. 6-25. The audio signal receiving device 102 may be configured to have a predetermined area and/or geofence 116 that may be configured to surround the audio signal receiving device 102. The audio signal receiving device 102 may be configured to detect one or more objects, such as, the contactless card 108, upon entry of the object into the predetermined area 116. Alternatively, or in addition, the audio signal receiving device 102 may be configured to detect such an object upon the object being positioned within a predetermined distance away from the audio signal receiving device 102, where the predetermined distance may be defined by the area 116.

One or more components of the system 100 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, one or more components of the system 100 may include any combination of hardware and/or software. In some implementations, one or more components of the system 100 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 100 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the system 100's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the environment 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some example implementations, one or more components of the environment 100 may execute one or more applications, such as software applications, that enable, for example, network communications with one or more components of environment 100 and transmit and/or receive data.

One or more components of the environment 100 may include and/or be in communication with one or more servers via one or more networks and may operate as a respective front-end to back-end pair with one or more servers. One or more components of the environment 100 may transmit, for example from a mobile device application (e.g., executing on one or more user devices, components, etc.), one or more requests to one or more servers (e.g., server(s) 318, as shown in FIG. 3). The requests may be associated with retrieving data from servers. The servers may receive the requests from the components of the system 100. Based on the requests, servers may be configured to retrieve the requested data from one or more databases (e.g., database 320, as shown in FIG. 3). Based on receipt of the requested data from the databases, the servers may be configured to transmit the received data to one or more components of the system 100, where the received data may be responsive to one or more requests.

The system 100 may include one or more networks. In some implementations, networks may be one or more of a wireless network, a wired network or any combination of wireless network and wired network and may be configured to connect the components of the system 100 and/or the components of the system 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 100.

One or more components of the system 100 may be configured to execute one or more transactions using one or more containers. In some implementations, each transaction may be executed using its own container. A container may refer to a standard unit of software that may be configured to include the code that may be needed to execute the action along with all its dependencies. This may allow execution of actions to run quickly and reliably.

In some implementations, as discussed above, the system 100 may be used for execution of communications between the audio signal receiving device 102 and the contactless card 108, such as, for example, for the purposes of repositioning of the contactless card 108 in order for the contactless card 108 to transmit contactless card data to the audio signal receiving device 102. In particular, the activation may be executed using a near-field communications (NFC) exchange link 110 between the contactless card 108 and the audio signal receiving device 102. To enable use of the NFC technology, a user (not shown in FIG. 1A) may bring the contactless card 108 within the area 116 of the audio signal receiving device 102 (e.g., tap the card 108 on the audio signal receiving device 102), whereby the audio signal receiving device 102 may be configured to detect presence of the contactless card 108 within the area 116 and execute one or more operations discussed herein. For example, the NFC exchange communication link 110 may be used in connection with execution of a transaction using the contactless card 108, e.g., any payment transactions and/or any other tasks, transactions, etc. The transactions may be desired to be executed at a point-of-sale terminal, using a vendor a website, and/or at any other location.

In the NFC exchange communication link 110, the audio signal receiving device 102 may be configured to act as an active component and provide power to energize the contactless card 108 (as discussed herein), which may be a passive component. Using the link 110, the audio signal receiving device 102 and the contactless card 108 may be configured to exchange various data, such as, for instance, for the purposes of activating the contactless card 108.

As shown in FIG. 1A, the audio signal receiving device 102 may include the transceiver coil 106, the processor 104, and an optional storage location (not shown in FIG. 1A). The transceiver coil 106 may be coupled to and/or be part of one or more circuits (not shown in FIG. 1A) and/or power sources (not shown in FIG. 1A) that may provide current to the transceiver coil 106 and/or detect signals that may be received by the transceiver coil 106 from the contactless card 108. As shown in FIG. 1A, the audio signal receiving device 102 includes a single transceiver coil 106, but, as can be understood, more than one transceiver coil 106 may be incorporated into the audio signal receiving device 102.

The transceiver coil 106 may transmit and/or receive one or more signals to/from the contactless card 108. The audio signal receiving device 102 may determine signal strength of these signals. For example, the audio signal receiving device 102 may measure current that may be supplied to the transceiver coil 106 for generation of signals for transmission to the contactless card 108 and/or current produced by the transceiver coil 106 as a result, for example, receipt of one or more signals from the contactless card 108. As can be understood, any other measurements and/or signal sensing may be performed for the purposes of determining signal strengths. The data associated with such measurements/sensing may be provided to the processor 104, which may determine signal strengths associated with each signal that may be transmitted/received by the transceiver coil 106. The processor 104 may use the signal strength data to determine the location of the contactless card 108 with respect to the audio signal receiving device 102. For example, as shown in FIG. 1A, the processor 104 of the audio signal receiving device 102 may determine that the contactless card 108 is located at position 1 112 based on the signal strength of a signal received from the contactless card 108, and, as shown in FIG. 1B, may determine that the contactless card 108 is located at position 2 114 based on the signal strength of another signal received from the contactless card 108. The processor 104 may determine that the signal strength (e.g., based on current measurement data) of the signal received from the contactless card 108 in position 1 112 may be lower than the signal strength of the signal received from the contactless card 108 in position 2 114, and thus, may determine that the contactless card 108 is located proximate to the audio signal receiving device 102 in position 2 114 and located distal to the audio signal receiving device 102 in position 1 112. Location of the contactless card 108 relative to the transceiver coil 106 may be used in determining positional sensitivity of the contactless card 108 with regard to the transceiver coil 106 and, hence, the audio signal receiving device 102, which, in turn, may enable guidance to the user for positioning of the contactless card 108 proximate to the transceiver coil 106 to ensure that signals having higher strength are being transmitted/received between the contactless card 108 and audio signal receiving device 102, thereby enabling transmission of contactless card data from the contactless card 108 to the audio signal receiving device 102 and providing more reliable communications.

In some implementations, as shown in FIG. 1B, the audio signal receiving device 102 may be configured to assist the user, through, for example, use of audio signals, in moving the 108 from one position, e.g., position 1 112, to another position, e.g., position 2 114, so as to improve quality and/or strength of signal transmissions between the contactless card 108 and audio signal receiving device 102.

For example, as discussed herein, the contactless card 108 may be located in position 1 112 (e.g., in user's hands and away from audio signal receiving device 102). The audio signal receiving device 102 may detect that the contactless card 108 is located within the area 116 of the audio signal receiving device 102. Once the contactless card 108 is detected within the area 116, the audio signal receiving device 102 may be configured to establish and/or attempt to establish an NFC exchange communication link 110 with the contactless card 108. The audio signal receiving device 102 may also generate an audio prompt and/or signal (e.g., a buzz sound and/or verbal instruction (e.g., “card too far”)) and/or alert indicating to the user that the contactless card 108 may be located to far from the transceiver coil 106 of the audio signal receiving device 102 and, hence, transmissions of signals between audio signal receiving device 102 and contactless card 108 may be difficult and/or not possible.

The audio signal may indicate to the user to move the contactless card 108 closer to the transceiver coil 106 of the audio signal receiving device 102. For example, the audio signal may include a verbal instruction to the user to move the contactless card 108 closer and/or in a specific direction. The audio signal receiving device 102 may generate further audio signals to the user indicating to the user whether position of the contactless card 108 has improved from its initial position, e.g., position 1 112, vis-a-vis the transceiver coil 106, to a position, e.g., position 2 114, where transmission of signals between the audio signal receiving device 102 and the 108 are possible. Once the contactless card 108 has been moved to position 2 114, the audio signal receiving device 102 may generate another prompt and/or signal and/or alert (e.g., a ding sound and/or a verbal indication) that an optimal (or substantially optimal) position of the contactless card 108 vis-a-vis the transceiver coil 106 of the audio signal receiving device 102 has been achieved, and thus, transmission of signals may be possible. In some example, non-limiting implementations, the position 2 114 may correspond to the user tapping the contactless card 108 on the audio signal receiving device 102. Alternatively, or in addition, the position 2 114 may correspond to the user holding the contactless card 108 near or proximate to the audio signal receiving device 102. As can be understood, position 2 114 may be any other position.

In some implementations, instead of generating audio signals to the user, the audio signal receiving device 102 may be configured to include a graphical user interface (not shown in FIG. 1B) that may display one or more instructions to the user for positioning/repositioning of the contactless card 108 so that it is proximate to the transceiver coil 106 and/or within a predetermined distance/area of the transceiver coil 106 of the audio signal receiving device 102. Upon determining that the contactless card 108 is located within the predetermined distance/area of the transceiver coil 106, the audio signal receiving device 102 may be configured to display an appropriate indication to the user that the contactless card 108 is located within such distance/area of the transceiver coil 106 and is ready for transmission of signals between the contactless card 108 and the audio signal receiving device 102. Once the contactless card 108 is located at position 2 114, transmission of data between the contactless card 108 and the audio signal receiving device 102 and/or any other computing device may be initiated and/or performed, as discussed in connection with FIG. 3.

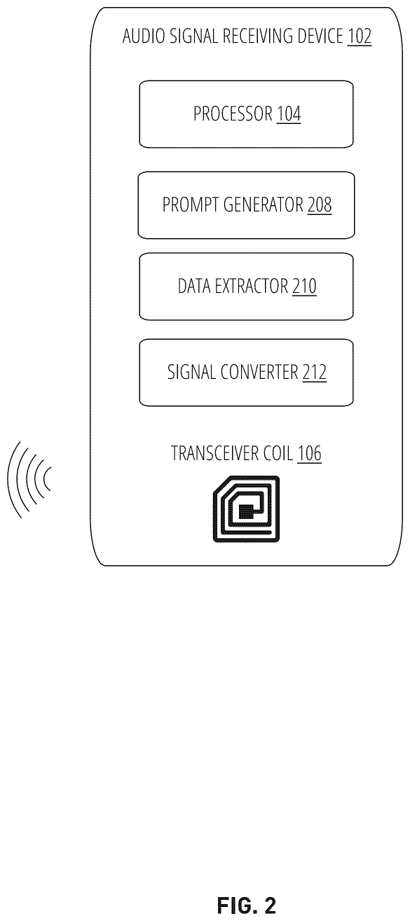

FIG. 2 illustrates further details of the audio signal receiving device 102, according to some implementations of the current subject matter. As shown in FIG. 2, in addition to the processor 104 and the transceiver coil 106, the audio signal receiving device 102 may be configured to include prompt generator 208, data extractor 210, and signal converter 212. The components 208-212 may be part of the processor 104 and/or be separate components.

The prompt generator 208 may be configured to generate one or more audio signals, prompts, alerts, etc., which may be used to assist the user in positioning and/or repositioning the contactless card 108 from position 1 112 to position 2 114, for example. The prompt generator 208 may generate such audio signals, prompts, alerts, etc. based on strength of signals received by the transceiver coil 106. The prompt generator 208 may be configured to generate different prompts to correspond to the specific position of the contactless card 108 in relation to the transceiver coil 106. For example, as discussed herein, the prompt generator 208 may generate “card too far” audio prompt that may be relayed to the user by the audio signal receiving device 102 when the contactless card 108 is at position 1 112. The prompt generator 208 may generate “card in position” audio prompt that may also be relayed to the user by the audio signal receiving device 102 when the contactless card 108 is at position 2 114. Alternatively, or in addition, the prompts may be different audio signals (e.g., buzz sounds, ding sounds, etc.).

The data extractor 210 may be configured to extract data from one or more signals received from the contactless card 108. As discussed herein, the contactless card 108 may be configured to transmit contactless card data using one or more signals that may be transmitted using communication link 110. The signals may include one or more data packets that may contain contactless card data and/or any other information that may be associated with the contactless card 108. Upon receipt of the signals from the contactless card 108, the data extractor 210 may extract the information associated with the contactless card 108 from the data packets contained in the signals received from the contactless card 108. The data extractor 210 may then provide the extracted data to the signal converter 212.

The signal converter 212 may use the extracted data to generate data packets for inclusion into one or more signals for transmission to a computing device (e.g., computing device 310 as shown in FIG. 3). The data packets generated by the signal converter 212 may then be used to generate one or more signals for transmission to the computing device. The prompt generation, extraction, conversion, signal generation, transmission, etc. processes performed by the components 208-212 may be executed in real time, simultaneously, in sequence, and/or as desired.

FIG. 3 illustrates an example of a processing system 300, according to some implementations of the current subject matter. The system 300 may include the contactless card 108, the audio signal receiving device 102, the computing device 310, a server 318, and a database 320. The components of the system 300 may include various combinations of hardware and/or software and/or may be communicatively coupled using various communication links, as discussed herein (for example, in relation to FIG. 1A). The system 300 may be configured to be used for execution of various transactions using the contactless card 108, which may, for example, include, but are not limited to, card activation transactions, purchasing transactions, authentication transactions, verification transactions, and/or any other transactions, and/or any combination thereof.

The computing device 310 may be any type of device (e.g., a mobile device, a computing device, a point-of-sale terminal, etc.). In some implementations, the computing device 310 may be securely linked to user's financial account at the financial institution that issued the contactless card 108 and where the user may access the financial account. The contactless card 108 may likewise be securely linked to the user's account. The linking of the user's computing device 310 and the account may be configured to allow the user's computing device 310 to execute one or more financial transactions (e.g., card activation transactions, purchasing transactions, authentication transactions, verification transactions, etc.). Access to the account from the computing device may be secured/protected using various authentication/authorization mechanisms (e.g., a facial recognition data, a fingerprint data, a biometric data, a username and a password, a multi-factor authentication token, and any combination thereof, etc.).

Once the contactless card 108 is positioned at position 2 114 (as shown in FIG. 1B), the audio signal receiving device 102, using the NFC exchange communication link 110, may be configured to request and/or be automatically provided with various identification data from the contactless card 108. The identification data may include various information identifying the card and/or the user of the card (e.g., one or more identifiers, etc.). In some example implementations, the contactless card 108 may be configured to transmit contactless card data that may be stored on the card to the audio signal receiving device 102, which, in turn, may transmit it to the computing device 310. Transmission of such data may be performed before, during and/or after execution of a transaction. The contactless card data may also be requested by the audio signal receiving device 102 and/or the computing device 310 to verify authenticity of the contactless card 108.

In some implementations, the data may also be transmitted, by the computing device 310 to the server 318 for any verification and/or further verification/authentication. Some non-limiting examples of the contactless card data may include at least one of the following: an account number associated with the contactless card, an expiration date associated with the contactless card, a card verification value (CVV) associated with the contactless card, a billing address associated with the contactless card, a name of a user associated with the contactless card, etc. Transmission of data to the server may be performed via any desired type of network. The computing device may be configured to transmit data to the server in one or more data packets.

The server 318 may be configured to store various data associated with the contactless card 108, the user that it is issued to, security and/or authentication information, data that may be used for activation and/or use of the card, etc. In some example implementations, the server 318 may also issue a query to the database 320, which may store some and/or all of the above and/or any other information related to the contactless card 108. The query may be used to search the database 320 to retrieve requested data. The data stored by the server 318 and/or in the database 320 may have been previously stored, such as, for example, when the contactless card 108 has been issued and/or manufactured by the issuer of the card.

In some implementations, transmissions of data between the contactless card 108, the audio signal receiving device 102, the computing device 310, the server 318, and/or the database 320 may be encrypted. Moreover, the data, including any secret keys, activation keys, stored keys, contactless card data, etc., may be encrypted. Thus, the computing device 310 and/or server 318 may execute various decryption algorithms to decrypt the data that they receive. Once the data has been decrypted, information may be extracted from the data packets. Further, prior to transmission of data (e.g., processed data, stored data, etc.), one or more components of the system 300, e.g., the contactless card 108, the audio signal receiving device 102, the computing device 310, and/or the server 318 may encrypt the data using any desired encryption algorithms.

In some implementations, the computing device 310 may execute a mobile application (e.g., a banking application, a commerce vendor application, a web browser application, etc.) that may be configured to generate one or more user interface(s) 316 on the computing device 310. Further, the user interface(s) 316 may include one or more fillable fields, which may be used for entry of various user authentication information, e.g., a facial recognition data, a fingerprint data, a biometric data, a username and a password, a multi-factor authentication token, and any combination thereof, to access user's account at the financial institution, such as, for example, to authenticate the user for the purposes of activating the contactless card 108. Moreover, the user interface(s) 316 may also include one or more fields that may be automatically populated based on the contactless card data received from the contactless card 108 and/or any data that may be stored by the computing device 310 and/or received from the server 318 and/or database 320. For example, the computing device 310 may be configured to populate the fillable fields with the contactless card data, which may include at least one of the following: an account number associated with the contactless card 108, a virtual account number associated with the contactless card 108, an expiration date associated with the contactless card 108, a card verification value (CVV) associated with the contactless card 108, a billing address associated with the contactless card 108, a name of a user associated with the contactless card 108, and/or any other information and/or any combination thereof. Moreover, the contactless card 108 may be any type of card, such as, for example, a credit card, a debit card, an electronic gift card, a pre-paid credit card, a pre-paid debit card, and any combination thereof.

The audio signal receiving device 102 and the computing device 310 may be configured to be communicatively coupled using one or more wireless communication links 314. The wireless communication links 314 may be of a different or same type as the communication link 110 between the contactless card 108 and the audio signal receiving device 102. For example, the link 110 may be an NFC exchange communication link, and the link(s) 314 may be BLUETOOTH, WIFI, etc.

In some implementations, using the communication link 110, the contactless card 108 may be configured to transmit contactless card data using one or more signals. The signals may include one or more data packets that may store contactless card data and/or any other information that may be associated with the contactless card 108. Upon receipt of the signals from the contactless card 108, the processor 104 of the audio signal receiving device 102 may be configured to convert the received signals into signals for transmission on the wireless communication link 314. As part of the conversion, the processor 104 (e.g., data extractor 210) may be configured to extract the information associated with the contactless card 108 from the data packets contained in the signals received from the contactless card 108. The processor 104 (e.g., signal converter 212) may then use these data packets to generate data packets for inclusion into one or more signals that are to be transmitted on the wireless communication link 314 to the computing device 310. The data packets generated by the processor 104 (e.g., signal converter 212) may then be used to generate one or more signals for transmission on the wireless communication link 314 and subsequently transmitted to the computing device 310. The extraction, conversion, signal generation, transmission, etc. processes performed by the respective contactless card 108, the audio signal receiving device 102, and/or the computing device 310 may be executed in real time, simultaneously, in sequence, and/or as desired. Moreover, as can be understood, the processor 104 may be configured to use the data packets received from the contactless card 108 and transmit them to the computing device 310 on the wireless communication link 314.

The signals transmitted by the audio signal receiving device 102 to the computing device 310 may be processed by the computing device 310. Processing of signals received from audio signal receiving device 102 may include extraction of data contained in one or more data packets transmitted as part of these signals. The data may include contactless card data associated with the contactless card 108. The computing device 310 may verify the contactless card data by communicating with the server 318, which may, in turn, communicate with database 320. The server 318 may execute various verification processes to verify the contactless card data and inform the computing device 310 accordingly. If verification is successful, the contactless card 108 may be used for the purposes of executing a transaction. Otherwise, transaction may be denied. Success or failure of execution of a transaction may be indicated to the user via the user interface(s) 316.

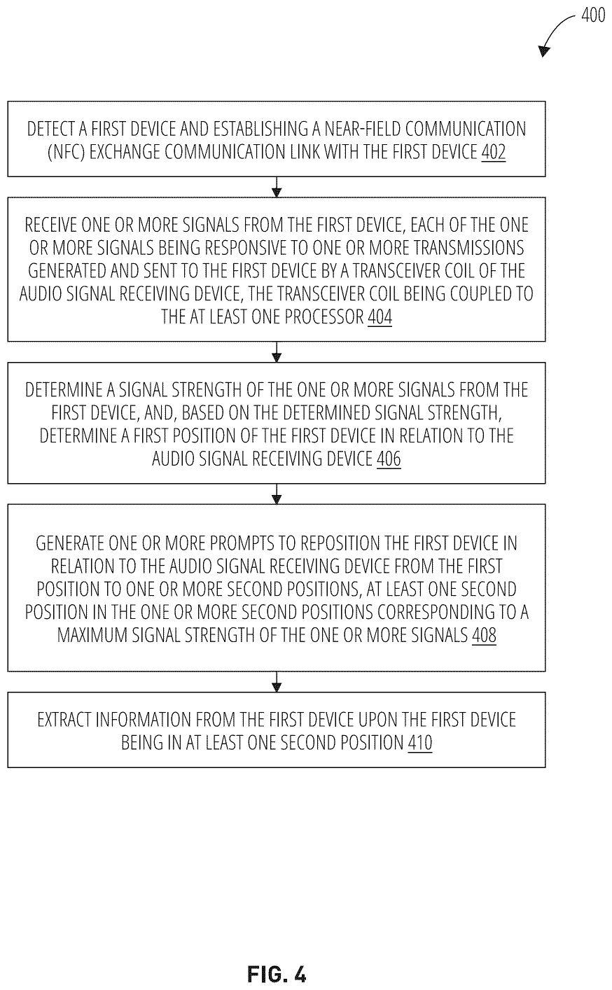

FIG. 4 illustrates an example process 400 for positioning and/or repositioning of a contactless card with respect to an audio signal receiving device, according to some implementations of the current subject matter. The process 400 may be executed using a system shown in FIGS. 1A-3, and in particular, for example, using a system that may include the contactless card 108 and the audio signal receiving device 102.

At 402, the audio signal receiving device 102 may be configured to detect a first device (e.g., contactless card 108) and establish a near-field communication (NFC) exchange communication link (e.g., link 110) with the first device.

At 404, the audio signal receiving device 102 may receive one or more signals from the first device. Each signal may be responsive to one or more transmissions generated and sent to the first device by a transceiver coil of the audio signal receiving device (e.g., transceiver coil 106 of the audio signal receiving device 102). The transceiver coil may be coupled to the processor (e.g., processor 104) of the audio signal receiving device.

At 406, the audio signal receiving device 102 may determine a signal strength of the signal(s) received from the first device. Based on the determined signal strength, the audio signal receiving device 102 may determine a first position of the first device in relation to the audio signal receiving device (e.g., position 1 112).

At 408, the audio signal receiving device 102 may generate one or more prompts (e.g., using the prompt generator 208) to reposition the first device in relation to the audio signal receiving device from the first position (e.g., position 1 112) to one or more second positions (e.g., position 2 114). The second position may correspond to a maximum signal strength of the signals received from the first device.

At 410, the audio signal receiving device 102 may extract information (e.g., contactless card data) from the first device upon the first device being positioned in the second position.

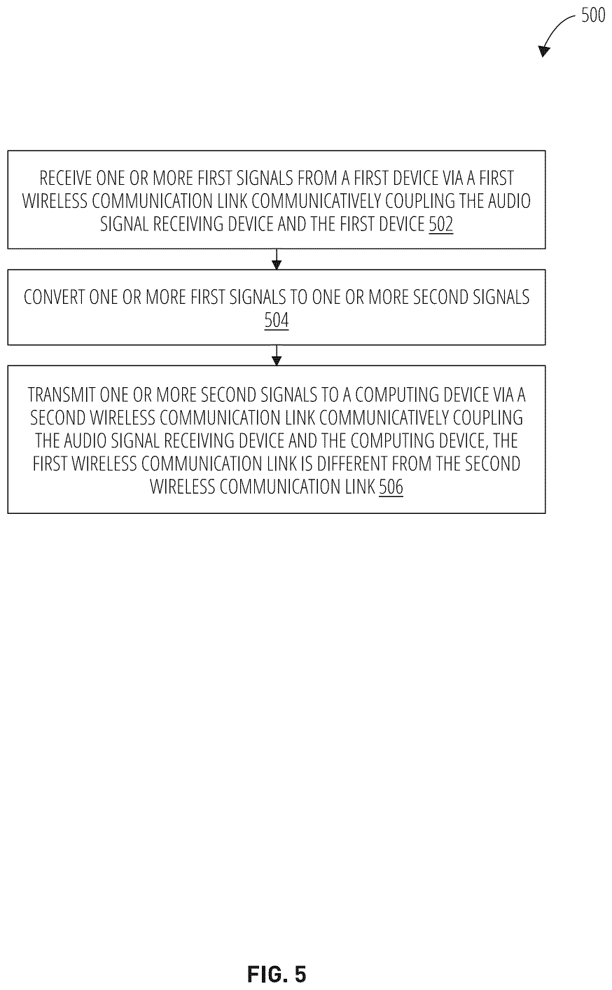

FIG. 5 illustrates an example process 500 for using an audio signal receiving device for transmission of information from a contactless card to a computing device, according to some implementations of the current subject matter. The process 500 may be executed using a system shown in FIG. 3, and in particular, for example, using a system that may include the contactless card 108, the audio signal receiving device 102, and the computing device 310.

At 502, the audio signal receiving device 102 may receive one or more first signals from a first device (e.g., the contactless card 108) via a first wireless communication link (e.g., NFC exchange communication link 110) communicatively coupling the audio signal receiving device and the first device.

At 504, the audio signal receiving device 102 may convert (e.g., using processor 104, data extractor 210, and/or signal converter 212) the first signals to one or more second signals.

At 506, the audio signal receiving device 102 may transmit the second signal(s) to a computing device (e.g., computing device 310) via a second wireless communication link (e.g., wireless communication link 314) communicatively coupling the audio signal receiving device and the computing device. In some implementations, the first wireless communication link (e.g., link 110) may be different from the second wireless communication link (e.g., link 314). Upon receiving the second signal(s), the computing device may generate one or more graphical user interfaces (e.g., user interface(s) 316) based on the second signal(s).

FIG. 6 illustrates a data transmission system 600 according to an example embodiment. As further discussed below, system 600 may include contactless card 602, client device 604, network 606, and server 608. Although FIG. 6 illustrates single instances of the components, system 600 may include any number of components.

System 600 may include one or more contactless cards 602, which are further explained below. In some embodiments, contactless card 602 may be in wireless communication, utilizing NFC in an example, with client device 604.

System 600 may include client device 604, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 604 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

In some examples, client device 604 of system 600 may execute one or more applications, such as software applications, that enable, for example, network communications with one or more components of system 600 and transmit and/or receive data.

The client device 604 may be in communication with one or more server(s) 608 via one or more network(s) 606, and may operate as a respective front-end to back-end pair with server 608. The client device 604 may transmit, for example from a mobile device application executing on client device 604, one or more requests to server 608. The one or more requests may be associated with retrieving data from server 608. The server 608 may receive the one or more requests from client device 604. Based on the one or more requests from client device 604, server 608 may be configured to retrieve the requested data from one or more databases (not shown). Based on receipt of the requested data from the one or more databases, server 608 may be configured to transmit the received data to client device 604, the received data being responsive to one or more requests.

System 600 may include one or more networks 606. In some examples, network 606 may be one or more of a wireless network, a wired network or any combination of wireless network and wired network, and may be configured to connect client device 604 to server 608. For example, network 606 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 606 may include, without limitation, telephone lines, fiber optics, IEEE Ethernet 802.3, a wide area network, a wireless personal area network, a LAN, or a global network such as the Internet. In addition, network 606 may support an Internet network, a wireless communication network, a cellular network, or the like, or any combination thereof. network 606 may further include one network, or any number of the exemplary types of networks mentioned above, operating as a stand-alone network or in cooperation with each other. network 606 may utilize one or more protocols of one or more network elements to which they are communicatively coupled. network 606 may translate to or from other protocols to one or more protocols of network devices. Although network 606 is depicted as a single network, it should be appreciated that according to one or more examples, network 606 may comprise a plurality of interconnected networks, such as, for example, the Internet, a service provider's network, a cable television network, corporate networks, such as credit card association networks, and home networks.

System 600 may include one or more servers 608. In some examples, server 608 may include one or more processors, which are coupled to memory. The server 608 may be configured as a central system, server or platform to control and call various data at different times to execute a plurality of workflow actions. Server 120 may be configured to connect to the one or more databases. The server 608 may be connected to at least one client device 604.

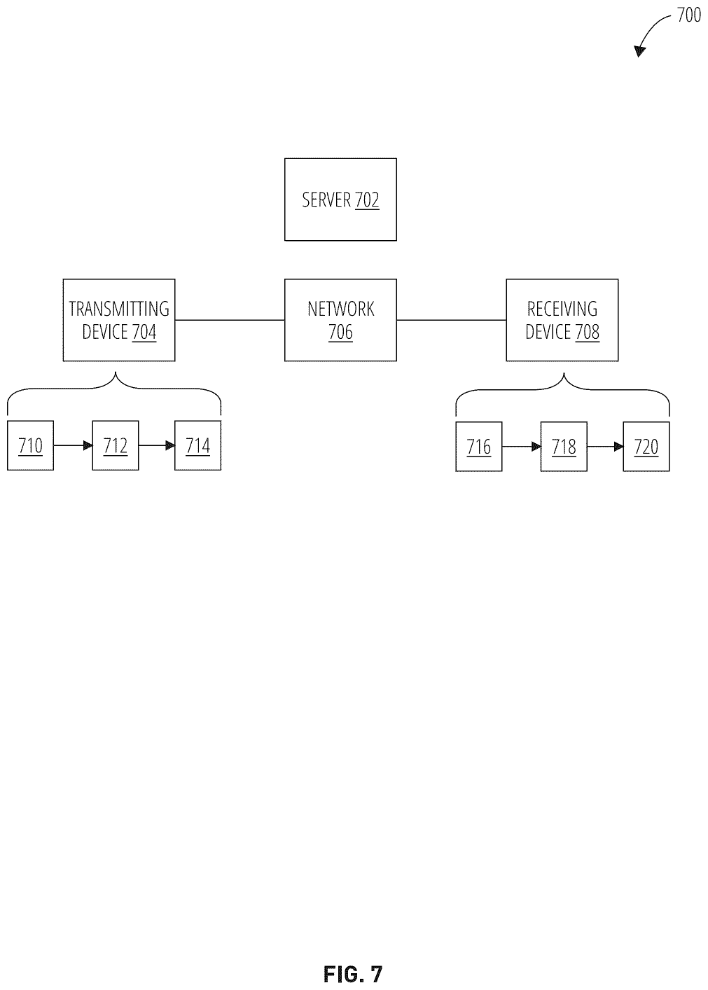

FIG. 7 illustrates a data transmission system according to an example embodiment. System 700 may include a transmitting or transmitting device 704, a receiving or receiving device 708 in communication, for example via network 706, with one or more servers 702. Transmitting device 604 may be the same as, or similar to, device (e.g., devices 102, 304, 310, 202) discussed above with reference to FIGS. 1A-B and 2. Receiving device 608 may be the same as, or similar to, device (e.g., devices 102, 304, 310, 202) discussed above with reference to FIGS. 1A-B. Network 706 may be similar to network or link 110, 312, 314, discussed above with reference to FIGS. 1A-B and 2. Although FIG. 7 shows single instances of components of system 700, system 700 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 7, system 700 may be configured to implement key diversification. For example, a sender and recipient may desire to exchange data (e.g., original sensitive data) via respective devices 704 and 708. As explained above, although single instances of transmitting device 704 and receiving device 708 may be included, it is understood that one or more transmitting devices 704 and one or more receiving devices 708 may be involved so long as each party shares the same shared secret symmetric key. In some examples, the transmitting device 704 and receiving device 708 may be provisioned with the same master symmetric key. Further, it is understood that any party or device holding the same secret symmetric key may perform the functions of the transmitting device 704 and similarly any party holding the same secret symmetric key may perform the functions of the receiving device 708. In some examples, the symmetric key may comprise the shared secret symmetric key which is kept secret from all parties other than the transmitting device 704 and the receiving device 708 involved in exchanging the secure data. It is further understood that both the transmitting device 704 and receiving device 708 may be provided with the same master symmetric key, and further that part of the data exchanged between the transmitting device 704 and receiving device 708 comprises at least a portion of data which may be referred to as the counter value. The counter value may comprise a number that changes each time data is exchanged between the transmitting device 704 and the receiving device 708.

System 700 may include one or more networks 706. In some examples, network 706 may be one or more of a wireless network, a wired network or any combination of wireless network and wired network, and may be configured to connect one or more transmitting devices 704 and one or more receiving devices 708 to server 702. For example, network 706 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 706 may include, without limitation, telephone lines, fiber optics, IEEE Ethernet 802.3, a wide area network, a wireless personal area network, a LAN, or a global network such as the Internet. In addition, network 706 may support an Internet network, a wireless communication network, a cellular network, or the like, or any combination thereof. Network 706 may further include one network, or any number of the exemplary types of networks mentioned above, operating as a stand-alone network or in cooperation with each other. Network 706 may utilize one or more protocols of one or more network elements to which they are communicatively coupled. Network 706 may translate to or from other protocols to one or more protocols of network devices. Although network 706 is depicted as a single network, it should be appreciated that according to one or more examples, network 706 may comprise a plurality of interconnected networks, such as, for example, the Internet, a service provider's network, a cable television network, corporate networks, such as credit card association networks, and home networks.

In some examples, one or more transmitting devices 704 and one or more receiving devices 708 may be configured to communicate and transmit and receive data between each other without passing through network 706. For example, communication between the one or more transmitting devices 704 and the one or more receiving devices 708 may occur via at least one of NFC, Bluetooth, RFID, Wi-Fi, and/or the like.

At block 710, when the transmitting device 704 is preparing to process the sensitive data with symmetric cryptographic operation, the sender may update a counter. In addition, the transmitting device 704 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 712, the transmitting device 704 may take the selected cryptographic algorithm, and using the master symmetric key, process the counter value. For example, the sender may select a symmetric encryption algorithm, and use a counter which updates with every conversation between the transmitting device 704 and the receiving device 708. The transmitting device 704 may then encrypt the counter value with the selected symmetric encryption algorithm using the master symmetric key, creating a diversified symmetric key.

In some examples, the counter value may not be encrypted. In these examples, the counter value may be transmitted between the transmitting device 704 and the receiving device 708 at block 712 without encryption.

At block 714, the diversified symmetric key may be used to process the sensitive data before transmitting the result to the receiving device 708. For example, the transmitting device 704 may encrypt the sensitive data using a symmetric encryption algorithm using the diversified symmetric key, with the output comprising the protected encrypted data. The transmitting device 704 may then transmit the protected encrypted data, along with the counter value, to the receiving device 708 for processing.

At block 716, the receiving device 708 may first take the counter value and then perform the same symmetric encryption using the counter value as input to the encryption, and the master symmetric key as the key for the encryption. The output of the encryption may be the same diversified symmetric key value that was created by the sender.

At block 718, the receiving device 708 may then take the protected encrypted data and using a symmetric decryption algorithm along with the diversified symmetric key, decrypt the protected encrypted data.

At block 720, as a result of the decrypting the protected encrypted data, the original sensitive data may be revealed.

The next time sensitive data needs to be sent from the sender to the recipient via respective transmitting device 704 and receiving device 708, a different counter value may be selected producing a different diversified symmetric key. By processing the counter value with the master symmetric key and same symmetric cryptographic algorithm, both the transmitting device 704 and receiving device 708 may independently produce the same diversified symmetric key. This diversified symmetric key, not the master symmetric key, is used to protect the sensitive data.

As explained above, both the transmitting device 704 and receiving device 708 each initially possess the shared master symmetric key. The shared master symmetric key is not used to encrypt the original sensitive data. Because the diversified symmetric key is independently created by both the transmitting device 704 and receiving device 708, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 704 and the receiving device 708 may be governed by symmetric requirements for how often to create a new diversification value, and therefore a new diversified symmetric key. In an embodiment, a new diversification value and therefore a new diversified symmetric key may be created for every exchange between the transmitting device 704 and receiving device 708.

In some examples, the key diversification value may comprise the counter value. Other non-limiting examples of the key diversification value include: a random nonce generated each time a new diversified key is needed, the random nonce sent from the transmitting device 704 to the receiving device 708; the full value of a counter value sent from the transmitting device 704 and the receiving device 708; a portion of a counter value sent from the transmitting device 704 and the receiving device 708; a counter independently maintained by the transmitting device 704 and the receiving device 708 but not sent between the two devices; a one-time-passcode exchanged between the transmitting device 704 and the receiving device 708; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 704 and the receiving device 708. In effect, this may create a one-time use key, such as a single-use session key.

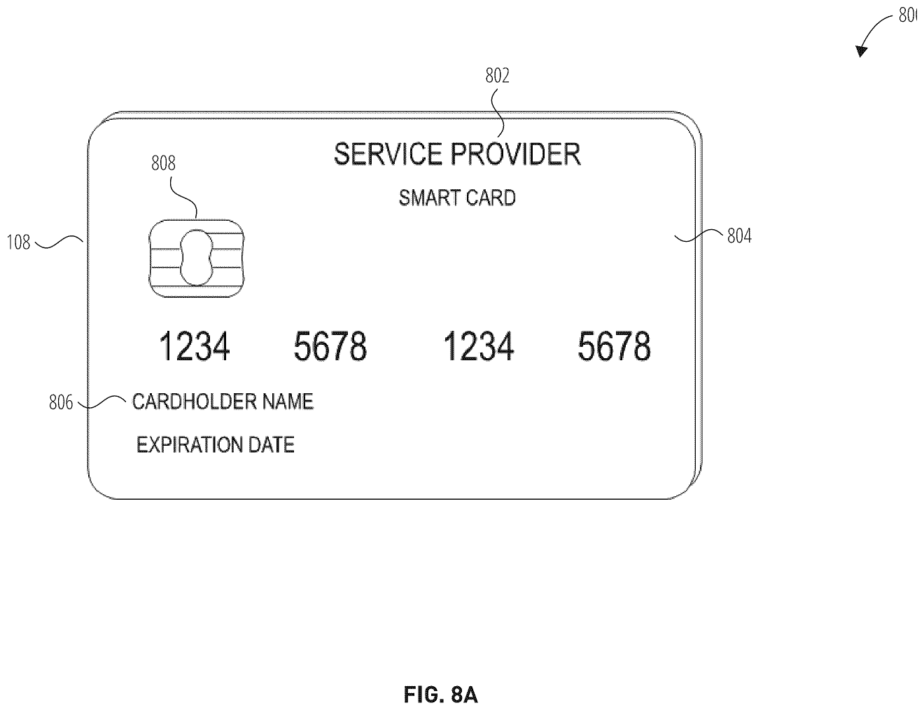

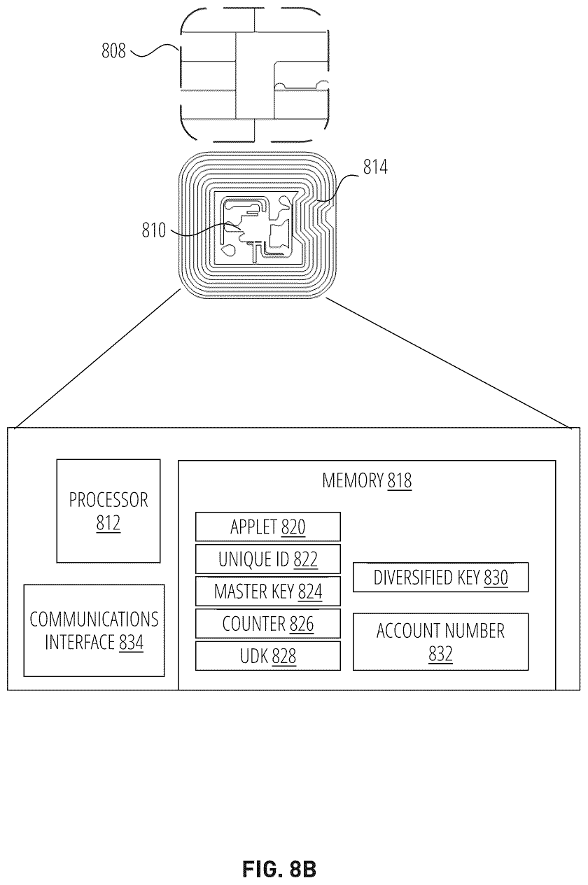

FIG. 8A is a schematic 800 illustrating an example configuration of a contactless card 108, which may include a payment card, such as a credit card, debit card, or gift card, issued by a service provider as displayed as service provider indicia 802 on the front or back of the contactless card 108. In some examples, the contactless card 108 is not related to a payment card, and may include, without limitation, an identification card. In some examples, the transaction card may include a dual interface contactless payment card, a rewards card, and so forth. The contactless card 108 may include a substrate 804, which may include a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 108 may have physical characteristics compliant with the ID-1 format of the ISO/IEC 7816 standard, and the transaction card may otherwise be compliant with the ISO/IEC 14443 standard. However, it is understood that the contactless card 108 according to the present disclosure may have different characteristics, and the present disclosure does not require a transaction card to be implemented in a payment card.

The contactless card 108 may also include identification information 806 displayed on the front and/or back of the card, and a contact pad 808. The contact pad 808 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 108 may also include processing circuitry, antenna and other components as will be further discussed in FIG. 8B. These components may be located behind the contact pad 808 or elsewhere on the substrate 804, e.g., within a different layer of the substrate 804, and may electrically and physically coupled with the contact pad 808. The contactless card 102 may also include a magnetic strip or tape, which may be located on the back of the card (not shown in FIG. 8A). The contactless card 108 may also include a Near-Field Communication (NFC) device coupled with an antenna capable of communicating via the NFC protocol. Embodiments are not limited in this manner.

As illustrated in FIG. 8B, the contact pad 808 of contactless card 108 may include processing circuitry 810 for storing, processing, and communicating information, including a processor 812, a memory 718, and one or more communications interface 834. It is understood that the processing circuitry 810 may contain additional components, including processors, memories, error and parity/CRC checkers, data encoders, anticollision algorithms, controllers, command decoders, security primitives and tamperproofing hardware, as necessary to perform the functions described herein.

The memory 818 may be a read-only memory, write-once read-multiple memory or read/write memory, e.g., RAM, ROM, and EEPROM, and the contactless card 108 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 818 may be encrypted memory utilizing an encryption algorithm executed by the processor 812 to encrypted data.

The memory 818 may be configured to store one or more applet 820, one or more counters 826, a unique ID 822, the master key 824, the UDK 828, diversified key 830, and the account number 832. The one or more applets 820 may comprise one or more software applications configured to execute on one or more contactless cards 108, such as a Java® Card applet. However, it is understood that applets 820 are not limited to Java Card applets, and instead may be any software application operable on contactless cards or other devices having limited memory. The one or more counters 826 may comprise a numeric counter sufficient to store an integer. The unique ID 822 may comprise a unique alphanumeric identifier assigned to the contactless card 108, and the identifier may distinguish the contactless card 102 from other contactless cards 108. In some examples, the unique ID 822 may identify both a customer and an account assigned to that customer.

The processor 812 and memory elements of the foregoing exemplary embodiments are described with reference to the contact pad 808, but the present disclosure is not limited thereto. It is understood that these elements may be implemented outside of the contact pad 808 or entirely separate from it, or as further elements in addition to processor 812 and memory 818 elements located within the contact pad 808.

In some examples, the contactless card 108 may comprise one or more antenna(s) 814. The one or more antenna(s) 814 may be placed within the contactless card 102 and around the processing circuitry 810 of the contact pad 808. For example, the one or more antenna(s) 814 may be integral with the processing circuitry 810 and the one or more antenna(s) 814 may be used with an external booster coil. As another example, the one or more antenna(s) 814 may be external to the contact pad 808 and the processing circuitry 810.

In an embodiment, the coil of contactless card 108 may act as the secondary of an air core transformer. The terminal may communicate with the contactless card 108 by cutting power or amplitude modulation. The contactless card 108 may infer the data transmitted from the terminal using the gaps in the power connection of the contactless card 108, which may be functionally maintained through one or more capacitors. The contactless card 108 may communicate back by switching a load on the coil of the contactless card 108 or load modulation. Load modulation may be detected in the terminal's coil through interference. More generally, using the antenna(s) 814, processor 812, and/or the memory 818, the contactless card 108 provides a communications interface to communicate via NFC, Bluetooth, and/or Wi-Fi communications.

As explained above, contactless card 108 may be built on a software platform operable on smart cards or other devices having limited memory, such as JavaCard, and one or more or more applications or applets may be securely executed. Applet 820 may be added to contactless cards to provide a one-time password (OTP) for multifactor authentication (MFA) in various mobile application-based use cases. Applet 820 may be configured to respond to one or more requests, such as near field data exchange requests, from a reader, such as a mobile NFC reader (e.g., of a mobile computing device (e.g., devices 102, 304, 310, 202) and/or point-of-sale terminal), and produce an NDEF message that comprises a cryptographically secure OTP encoded as an NDEF text tag. The NDEF message may include a cryptogram, and any other data.

One example of an NDEF OTP is an NDEF short-record layout (SR=1). In such an example, one or more applets 820 may be configured to encode the OTP as an NDEF type 4 well known type text tag. In some examples, NDEF messages may comprise one or more records. The applet 820 may be configured to add one or more static tag records in addition to the OTP record.

In some examples, the one or more applets 820 may be configured to emulate an RFID tag. The RFID tag may include one or more polymorphic tags. In some examples, each time the tag is read, different cryptographic data is presented that may indicate the authenticity of the contactless card. Based on the one or more applets 820, an NFC read of the tag may be processed, the data may be transmitted to a server, such as a server of a banking system, and the data may be validated at the server.

In some examples, the contactless card 108 and server may include certain data such that the card may be properly identified. The contactless card 108 may include one or more unique identifiers (not pictured). Each time a read operation takes place, the counter 826 may be configured to increment. In some examples, each time data from the contactless card 108 is read (e.g., by a mobile device), the counter 826 is transmitted to the server for validation and determines whether the counter 826 are equal (as part of the validation) to a counter of the server.

The one or more counter 826 may be configured to prevent a replay attack. For example, if a cryptogram has been obtained and replayed, that cryptogram is immediately rejected if the counter 826 has been read or used or otherwise passed over. If the counter 826 has not been used, it may be replayed. In some examples, the counter that is incremented on the contactless card 108 is different from the counter that is incremented for transactions. The contactless card 108 is unable to determine the application transaction counter 826 since there is no communication between applets 820 on the contactless card 108. In some examples, the contactless card 108 may comprise a first applet 720-1, which may be a transaction applet, and a second applet 720-2. Each applet 720-1 and 720-2 may comprise a respective counter 826.

In some examples, the counter 826 may get out of sync. In some examples, to account for accidental reads that initiate transactions, such as reading at an angle, the counter 826 may increment but the application does not process the counter 826. In some examples, when the computing device (e.g., devices 102, 304, 310, 202) is woken up, NFC may be enabled and the computing device (e.g., devices 102, 304, 310, 202) may be configured to read available tags, but no action is taken responsive to the reads.

To keep the counter 826 in sync, an application, such as a background application, may be executed that would be configured to detect when the computing device (e.g., devices 102, 304, 310, 202) wakes up and synchronize with the server of a banking system indicating that a read that occurred due to detection to then move the counter 826 forward. In other examples, Hashed One Time Password may be utilized such that a window of mis-synchronization may be accepted. For example, if within a threshold of 10, the counter 826 may be configured to move forward. But if within a different threshold number, for example within 10 or 20, a request for performing re-synchronization may be processed which requests via one or more applications that the user tap, gesture, or otherwise indicate one or more times via the user's device. If the counter 826 increases in the appropriate sequence, then it possible to know that the user has done so.

The key diversification technique described herein with reference to the counter 726, master key 824, UDK 828, and diversified key 830, is one example of encryption and/or decryption a key diversification technique. This example key diversification technique should not be considered limiting of the disclosure, as the disclosure is equally applicable to other types of key diversification techniques.

During the creation process of the contactless card 108, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 108. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys (e.g., the UDKs 828) and the counter may be used as diversification data. For example, each time the contactless card 108 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

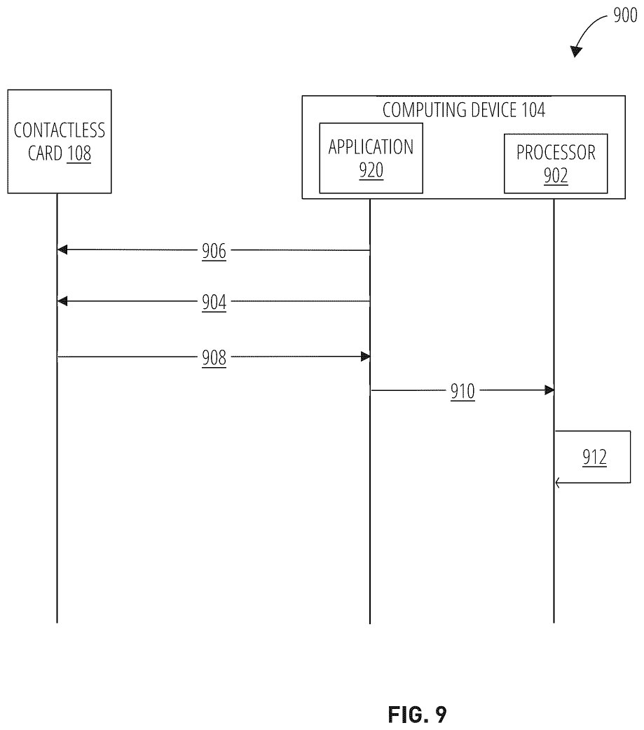

FIG. 9 is a timing diagram illustrating an example sequence for providing authenticated access according to one or more embodiments of the present disclosure. Sequence flow 900 may include contactless card 108 and computing device (e.g., devices 102, 304, 310, 202), which may include an application 920 and processor 902. The application 920 can be any of the applications that execute on the computing device (e.g., devices 102, 304, 310, 202).

At line 906, the application 920 communicates with the contactless card 108 (e.g., after being brought near the contactless card 108). Communication between the application 920 and the contactless card 108 may involve the contactless card 108 being sufficiently close to a card reader (not shown) of the computing device (e.g., devices 102, 304, 310, 202) to enable NFC data transfer between the application 820 and the contactless card 108.

At line 904, after communication has been established between computing device (e.g., devices 102, 304, 310, 202) and contactless card 108, contactless card 108 generates a message authentication code (MAC) cryptogram. In some examples, this may occur when the contactless card 108 is read by the application 920. In particular, this may occur upon a read, such as an NFC read, of a near field data exchange (NDEF) tag, which may be created in accordance with the NFC Data Exchange Format. For example, a reader application, such as application 920, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 108 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 920 may be configured to transmit a request to contactless card 102, the request comprising an instruction to generate a MAC cryptogram.

At line 908, the contactless card 108 sends the MAC cryptogram to the application 820. In some examples, the transmission of the MAC cryptogram occurs via NFC, however, the present disclosure is not limited thereto. In other examples, this communication may occur via Bluetooth, Wi-Fi, or other means of wireless data communication. At line 910, the application 920 communicates the MAC cryptogram to the processor 902.

At line 912, the computing device (e.g., devices 102, 304, 310, 202), using a processor 902, verifies the MAC cryptogram pursuant to an instruction from the application 920. For example, the MAC cryptogram may be verified, as explained below. In some examples, verifying the MAC cryptogram may be performed by a device other than computing device 104. For example, processor 902 may output the MAC cryptogram for transmission to a server, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

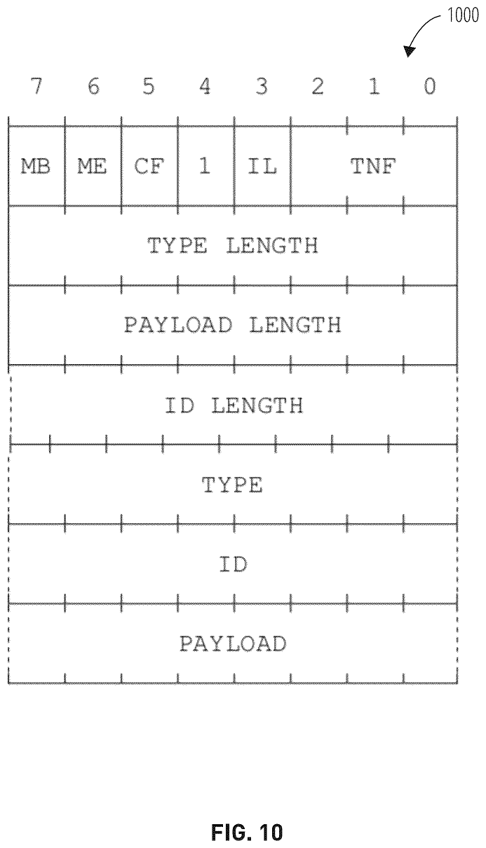

FIG. 10 illustrates an NDEF short-record layout (SR=1) data structure 1000 according to an example embodiment. One or more applets 820 may be configured to encode an OTP as an NDEF type 4 well known type text tag. In some examples, NDEF messages may comprise one or more records. The applets may be configured to add one or more static tag records in addition to the OTP record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 1000 may include a cryptogram and any other data provided by the applet 820.

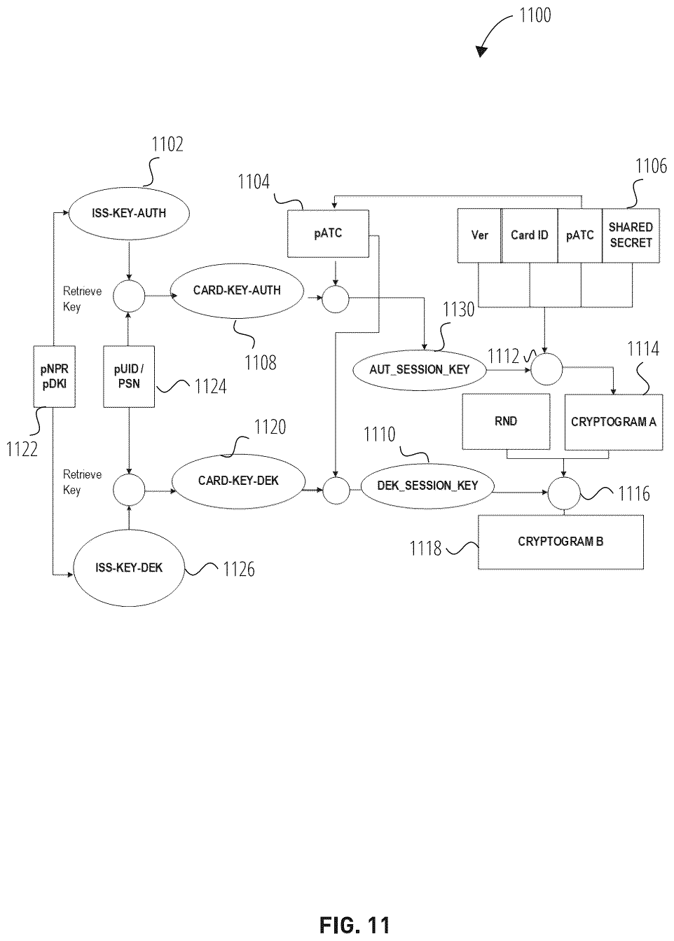

FIG. 11 illustrates a diagram of a system 1100 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1102, 1126 may be required for each part of the portfolio on which the one or more applets is issued. For example, the first master key 1102 may comprise an Issuer Cryptogram Generation/Authentication Key (Iss-Key-Auth) and the second master key 1126 may comprise an Issuer Data Encryption Key (Iss-Key-DEK). As further explained herein, two issuer master keys 1102, 1126 are diversified into card master keys 1108, 1120, which are unique for each card. In some examples, a network profile record ID (pNPR) 522 and derivation key index (pDKI) 1124, as back office data, may be used to identify which Issuer Master Keys 1102, 1126 to use in the cryptographic processes for authentication. The system performing the authentication may be configured to retrieve values of pNPR 1122 and pDKI 1124 for a contactless card at the time of authentication.

In some instances, the issuer master keys 1102, 1126 may not be stored on the card but may be utilized at the time of manufacture of provisioning of the card to generate the card master keys 1108, 1120. The card master keys 1108, 1120 may be securely provisioned and stored on the contactless card. As discussed below, the card master keys 1108, 1120 are then utilized to generate diversified session keys 1130, 1110.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1108 and Card-Key-Dek 1120). The session keys (Aut-Session-Key 1130 and DEK-Session-Key 1110) may be generated by the one or more applets and derived by using the application transaction counter (pATC) 1104 with one or more algorithms. To fit data into the one or more algorithms, only the 2 low order bytes of the 4-byte pATC 1104 is used. In some examples, the four byte session key derivation method may comprise: F1 :=PATC (lower 2 bytes) ∥ ‘F0’∥ ‘00’∥ PATC (four bytes) F1 :=PATC (lower 2 bytes) ∥ ‘0F’∥ ‘00’∥ PATC (four bytes) SK :={(ALG (MK) [F1]) ∥ ALG (MK) [F2]}, where ALG may include 3DES ECB and MK may include the card unique derived master key.

As described herein, one or more MAC session keys may be derived using the lower two bytes of pATC 1104 counter. At each tap of the contactless card 108, pATC 1104 is configured to be updated, and the card master keys Card-Key-AUTH 508 and Card-Key-DEK 1120 are further diversified into the session keys Aut-Session-Key 1130 and DEK-Session-KEY 1110. pATC 1104 may be initialized to zero at personalization or applet initialization time. In some examples, the pATC counter 1104 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1130. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1130, as explained above. As explained above, the low order two bytes of the counter may be used to diversify for the one or more MAC session keys. As explained below, AUT-Session-Key 1130 may be used to MAC data 1106, and the resulting data or cryptogram An 1114 and random number RND may be encrypted using DEK-Session-Key 1110 to create cryptogram B or output 1118 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1110 derived from the Card-Key-DEK 1120. In this case, the ATC value for the session key derivation is the least significant byte of the counter pATC 1104.

The format below represents a binary version example embodiment. Further, in some examples, the first byte may be set to ASCII ‘A’

| Message Format | | | | |
|---|---|---|---|---|
| 1 | 2 | 4 | 8 | 8 |
| 0x43 (Message | Version | pATC | RND | Cryptogram A |
| Type ‘A’) | | | | (MAC) |
| Cryptogram A (MAC) | 8 bytes | | | |
| MAC of | | | | |
| 2 | 8 | 4 | 4 | 18 bytes input data |
| Version | pUID | pATC | Shared Secret | |
| Message Format | | | | |
| 1 | 2 | 4 | | 16 |
| 0x43 (Message | Version | pATC | | Cryptogram B |
| Type ‘A’) | | | | |
| Cryptogram A (MAC) | 8 bytes | | | |
| MAC of | | | | |
| 2 | 8 | 4 | 4 | 18 bytes input |
| | | | | data |
| Version | pUID | pATC | Shared Secret | |
| Cryptogram B | 16 | | | |
| Sym Encryption of | | | | |
| 8 | 8 | | | |
| RND | Cryptogram A | | | |

Another exemplary format is shown below. In this example, the tag may be encoded in hexadecimal format.

| Message Format | | | | |
|---|---|---|---|---|
| 2 | 8 | 4 | 8 | 8 |
| Version | pUID | pATC | RND | Cryptogram A |
| | | | | (MAC) |
| 8 bytes | | | | |
| 8 | 8 | 4 | 4 | 18 bytes input data |
| pUID | pUID | pATC | Shared Secret | |
| Message Format | | | | |
| 2 | 8 | 4 | | 16 |
| Version | pUID | pATC | | Cryptogram B |
| 8 bytes | | | | |
| 8 | | 4 | 4 | 18 bytes input data |
| pUID | pUID | pATC | Shared Secret | |
| Cryptogram B | 16 | | | |
| Sym Encryption of | | | | |
| 8 | 8 | | | |
| RND | Cryptogram A | | | |

The UID field of the received message may be extracted to derive, from master keys Iss-Key-AUTH 502 and Iss-Key-DEK 1126, the card master keys (Card-Key-Auth 1108 and Card-Key-DEK 1120) for that particular card. Using the card master keys (Card-Key-Auth 508 and Card-Key-DEK 1120), the counter (pATC) field of the received message may be used to derive the session keys (Aut-Session-Key 1130 and DEK-Session-Key 1110) for that particular card. Cryptogram B 1118 may be decrypted using the DEK-Session-KEY, which yields cryptogram An 1114 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram An 1114, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1130. The input data 1106 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1112, data 1106 is processed through the MAC using Aut-Session-Key 1130 to produce MAC output (cryptogram A) 1114, which is encrypted.

In order to provide additional protection against brute force attacks exposing the keys on the card, it is desirable that the MAC cryptogram 1114 be enciphered. In some examples, data or cryptogram An 1114 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1110. In the encryption operation 1116, data or cryptogram An 1114 and RND are processed using DEK-Session-Key 510 to produce encrypted data, cryptogram B 1118. The data 1114 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

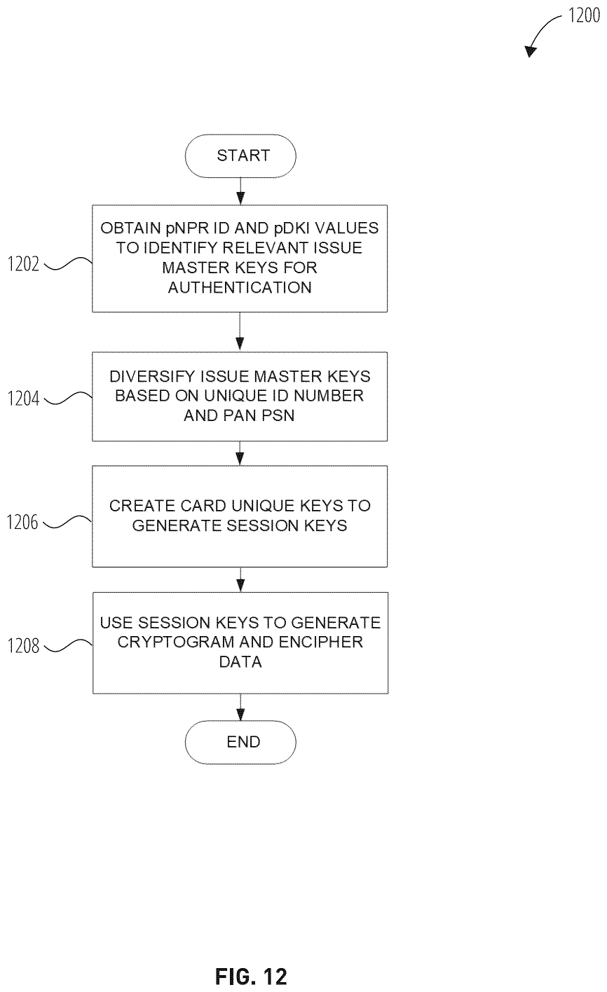

FIG. 12 illustrates a method 1200 for generating a cryptogram. For example, at block 1202, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1204, Issuer Master Keys may be diversified by combining them with the card's unique ID number (pUID) and the PAN sequence number (PSN) of one or more applets, for example, a payment applet.

At block 1206, Card-Key-Auth and Card-Key-DEK (unique card keys) may be created by diversifying the Issuer Master Keys to generate session keys which may be used to generate a MAC cryptogram.

At block 1208, the keys used to generate the cryptogram and encipher the data in the one or more applets may comprise the session keys of block 1030 based on the card unique keys (Card-Key-Auth and Card-Key-DEK). In some examples, these session keys may be generated by the one or more applets and derived by using pATC, resulting in session keys Aut-Session-Key and DEK-Session-Key.

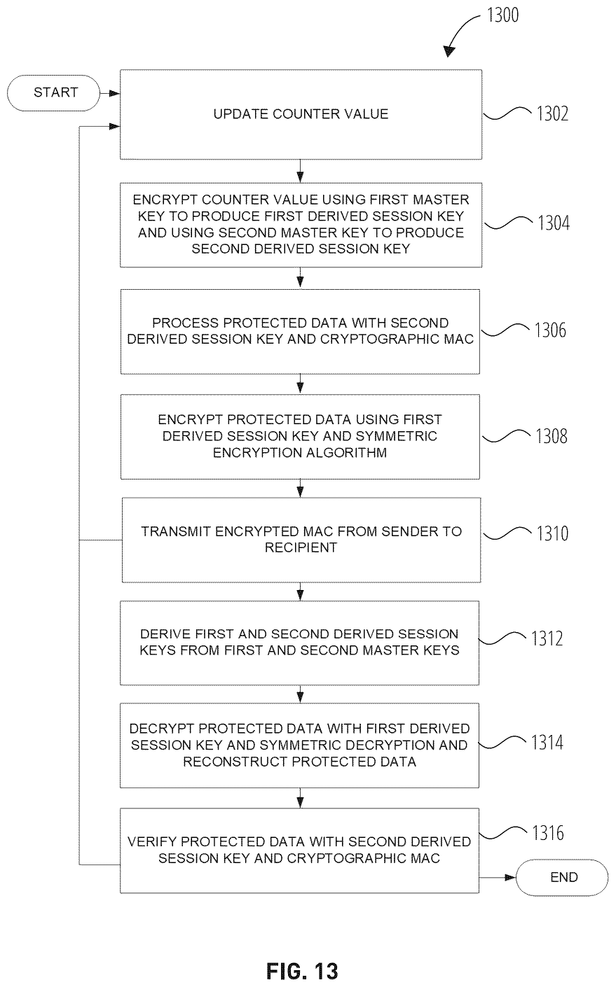

FIG. 13 depicts an exemplary process 1300 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1302, and other data, such as data to be protected, which it may secure share with the recipient.

At block 1304, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1306, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1308, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1310, the encrypted MAC is transmitted, from the sender to the recipient, with sufficient information to identify additional secret information (such as shared secret, master keys, etc.), for verification of the cryptogram.

At block 1312, the recipient uses the received counter value to independently derive the two derived session keys from the two master keys as explained above.

At block 1314, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1316, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1302) and a new set of session keys may be created (at block 1310). In some examples, the combined random data may be discarded.

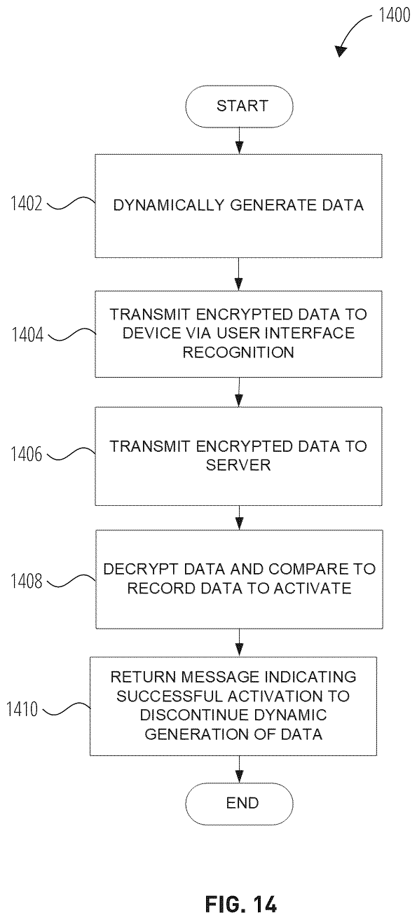

FIG. 14 illustrates a method 1400 for card activation according to an example embodiment. For example, card activation may be completed by a system including a card, a device, and one or more servers. The contactless card, device, and one or more servers may reference same or similar components that were previously explained, such as contactless card 108, 302, computing device 102, 304, 310, 202.

In block 1402, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1404, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1406, the one or more portions of the data may be communicated to one or more servers, such as a card issuer server. For example, one or more encrypted portions of the data may be transmitted from the device to the card issuer server for activation of the card.

In block 1408, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1410, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

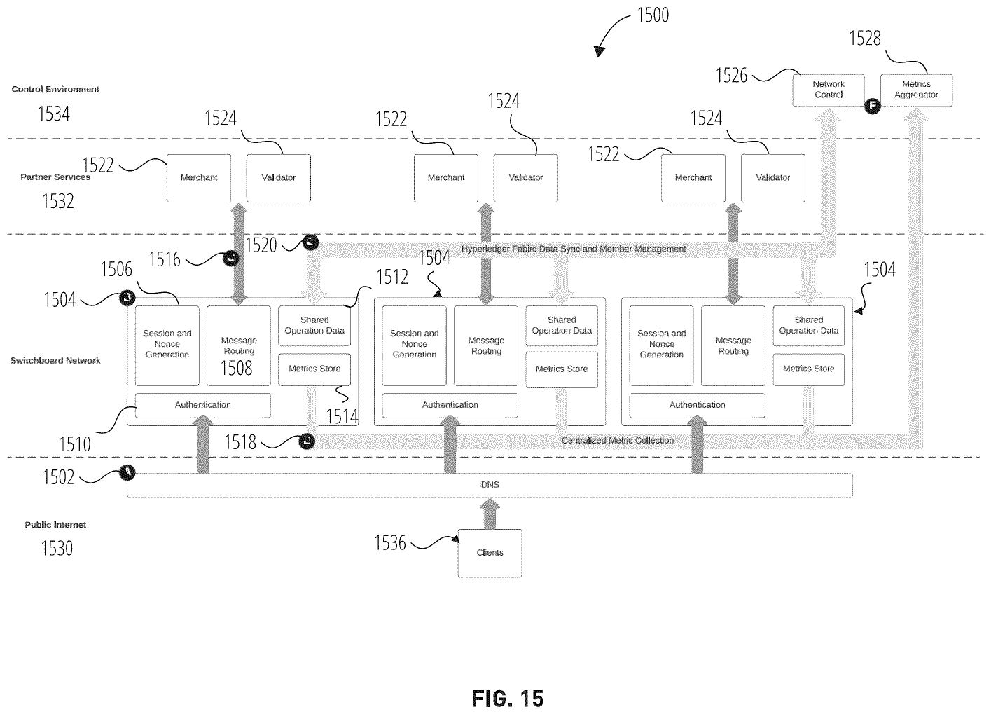

FIG. 15 illustrates an example of system 1500 in accordance with the embodiments discussed herein. The system 1500 includes additional devices and systems configured to enable contactless card issuers to tap-to-card services in a distributed environment. Specifically, system 1500 enables any number of card issuer systems to provide card services including authentication to their clients through a switching fabric, i.e., the switchboard system, in a secure and safe manner.

In embodiments, the system 1500 includes one or more nodes 1504 configured to perform routing operations. Each switchboard node 1504 may include a session and nonce generator 1506, a message router 1508, authentication 1510 module, an operation data 1512 store, and a metrics store 1514. Further, each of the nodes may be configured the same and share configurations, but each switchboard node 1504 may independently process and route messages and requests to the appropriate systems, such as the merchant (authenticator) systems and issuer systems. Each of the nodes 1504 is configured to act as a broker of trust between an issuer system, the merchant system 1522, and/or validation system 1524, for example. Each switchboard node 1504 is configured to route each message to the correct issuer system while maintaining data security. For example, a switchboard node 1504 may route a message between an issuer system and merchant system while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 1504. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 1504 may operate in a cloud-based computing environment, e.g., a collection of hardware, software, and networking components that enable the delivery of cloud computing services. The switchboard nodes 1504 and the computing services are delivered over the Internet, and they can be accessed from anywhere in the world with an Internet connection. In embodiments, a client 1536 may access a switchboard node 1504 through Domain Name System 1502 or domain name system (DNS). The DNS 1502 a hierarchical and distributed naming system for computers, services, and other resources connected to the Internet or other networks. It associates various information with domain names assigned to each registered participant. In one example, the DNS 1502 may translate a name known to software executing on a client 1536 to route data to one or more of switchboard node 1504 of the switchboard system. In embodiments, the DNS 1502 may generate into a number, such as an Internet Protocol (IP) address, an address record (A-record), or another Host name (C-name record). At a high level, the Domain Name System 1502 translates known domain names to numerical Internet Protocol (IP) addresses needed for locating and identifying computer services and devices with the underlying network protocols. Clients use the global DNS system to select the best node to use.

In embodiments, a client 1536 communicates with the switchboard system to perform one or more of the partner services 1532, such as conducting a transaction with a merchant, validate the customer, or other tap-to functions. Once the client 1536 identifies a switchboard node 1504 and resolves an address to communicate with the switchboard node 1504, the client 1536 may send one or more messages to the switchboard node 1504 to authenticate and perform the operation. The switchboard node 1504 includes an authentication 1510 function that is configured to authenticate the client 1536. In embodiments, the client 1536 sends a message or authorization request to the switchboard node 1504 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client | Individual |
| | ID | identifier |
| | | of client |
| GReyx5BnEAaE72bWbFZJfHRL8Dbt1Uum | Client | Randomly |
| | Key | assigned key |

The switchboard node 1504 may authorize or authenticate the client 1536 or user, and the switchboard node 1504 may utilize the additional components, such as the session and nonce generator 1506 and message router 1508, to perform the operations. Note the validators or validation systems 1524 never interact with the merchant systems 1522, nor vice versa. The nodes 1504 brokers all communication.

In some embodiments, the switchboard system may utilize a hyperledger fabric 1520 to manage synchronizing the shared operation data 1512 and member management across the network. The hyperledger fabric 1520 is distributed ledger framework having a permissioned network model that only authorized participants can join the network and access the data that is stored on a ledger.

In embodiments, the hyperledger fabric 1520 may be generated by creating one or more set of peers, an ordering service, and a channel. Once the network is created, the system 1500 deploys chaincode to the network or nodes 1504 permitted to access the fabric. The chaincode is the code that runs on the blockchain and executes the network control 1526 and operation data 1512 logic code. Once the chaincode is deployed, each of the switchboard nodes 1504 is configured to invoke transactions on the blockchain to add data to the blockchain, e.g., the operational data. A switchboard node 1504 or another device can query the ledger to retrieve data. The ledger is a distributed database that stores all of the data that has been added to the blockchain.

All nodes 1504 keep an independently verifiable log of their actions that can be transmitted to a centralized aggregator to build a picture of overall network usage. At a central level, system 1500 can manage network operation data and management and have a centralized view of network use, aggregated and abstracted to the appropriate level.

In accordance with embodiments discussed herein, the system 1500 enables any number of contactless card issuers to provide contactless cards 108 to their customers. The customers may utilize their contactless cards 108 to authenticate themselves to post messages on a social media site, for example. System 1500 may route data, e.g., a cryptogram, encrypted data, signed data, etc. from a contactless card 102 through the client 1536 to the appropriate authenticator or validator, e.g., partner services 1532 and/or validation system 1524. The data may be authenticated and result may be returned to the correct server to enable an operation to be performed, e.g., posting an authenticated post on a social media site.

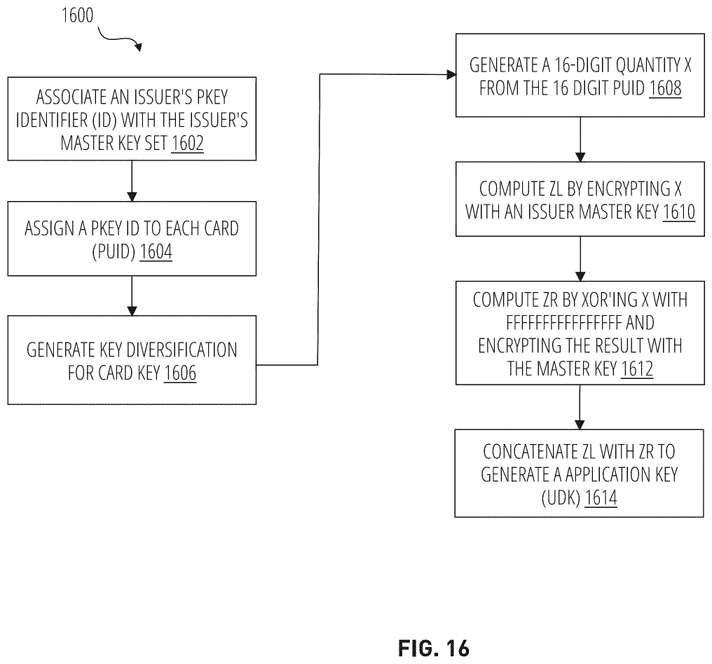

In a multi-issuer distributed environment, each issuer may be associated with and generate their own master keys that may be used to further generate card master keys for each card issued. The flows discussed in FIG. 16 through FIG. 20 may be performed to generate encrypted data that may be properly routed through system 1500 to perform authentication techniques. These flows may be different than flows discussed in FIG. 11 through FIG. 14, which are generally performed in a single card issuer environment. Embodiments are not limited in this manner.

FIG. 16 illustrates flow 1600, an example of operations to identify the issuer's master keys and generate unique card master keys or application keys. In some instances, these operations may be performed off the card, at personalization time, and then stored in a memory of the card. Further, the issuer's master key(s) may be utilized to generate card master keys. The card master keys may be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, these one or more of the operations may be performed on card, e.g., at the time of manufacturer, each time an operation is performed with a key, and so forth.

At block 1602, embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the operations discussed in blocks block 1604 to block 1614.

At block 1604, the system assigns a pKey ID to a card or pUID, a card application's unique 16-decimal digital identify. At block 1606, the system initiates generating a card's UDK(s). At block 1608, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

At block 1610, the system computes or calculates (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

At block 1612, the system calculates or computes ZR is by XOR'ing X with FFFFFFFFFFFFFFFF and encrypting the result with an issuer master key. Again, an encryption algorithm such as DES, AES, RSA, etc, may be used to encrypt the result of the XOR'ing. At block 1614, the system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys.

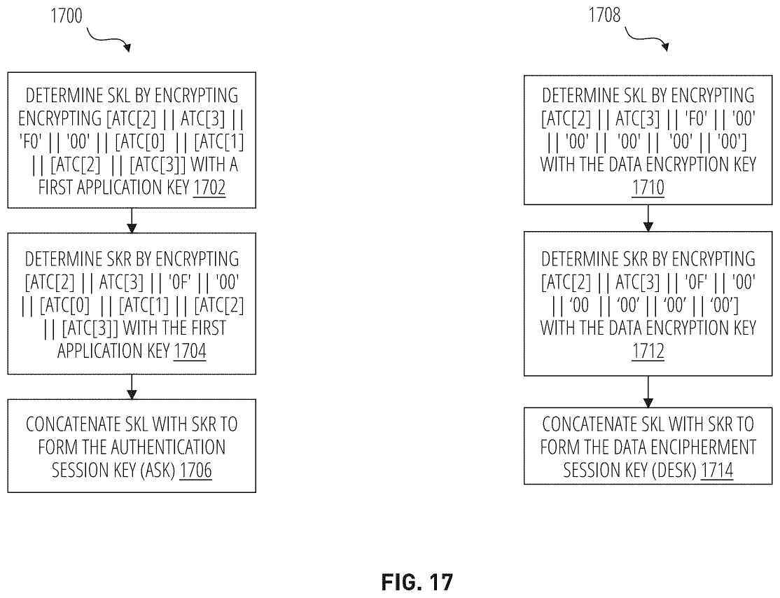

FIG. 17 illustrates a first flow 1700 to generate a unique cryptogram session key (ASK) and a second flow 1708 to generate a unique encipherment session key (DESK) in accordance embodiments. The operations discussed in flow 1700 and flow 1708 may be performed on the contactless card.

At block 1702, the contactless card including circuitry compute SKL by encrypting [ATC[2] ∥ ATC[3] ∥ ‘F0’ ∥ ‘00’ ∥ [ATC[0] ∥ [ATC[1] ∥ [ATC[2] ∥ [ATC[3]] with an application key, e.g., the key generated in flow 1600. Further, at block 1704 the contactless card compute SKR by encrypting [ATC[2] ∥ ATC[3] ∥ ‘0F’ ∥ ‘00’ ∥ [ATC[0] ∥ [ATC[1] ∥ [ATC[2] ∥ [ATC[3]] with the application key. Finally, and at block 1706, the contactless card concatenates SKL with SKR to form an authentication session key (ASK). In embodiments, the ASK is used to perform operations utilizing the contactless card, such as encrypting the cryptographic MAC.

In embodiments, a card applet also supports session key derivation to generate a unique encipherment session key DESK as shown in flow 1708. At block 1710, the contactless card including circuitry Compute SKL by encrypting [ATC[2] ∥ ATC[3] ∥ ‘F0’∥ ‘00’ ∥ ‘00’ ∥ ‘00’ ∥ ‘00’] with the Data Encryption Key (DEK) Further and at block 1712, the contactless card computes SKR by encrypting [ATC[2] ∥ ATC[3] ∥ ‘0F’ ∥ ‘00’ ∥ ‘00’ ∥ ‘00’ ∥ ‘00’ ∥ ‘00’] with the Data Encryption Key At block 1714, the contactless card concatenate SKL with SKR to form the Data Encipherment Session Key.

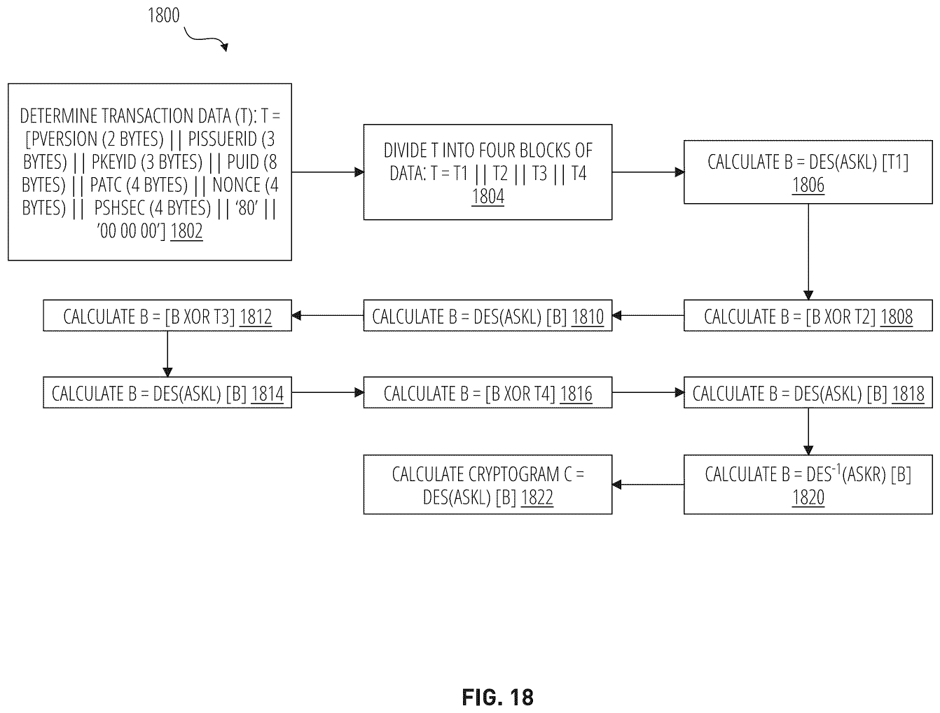

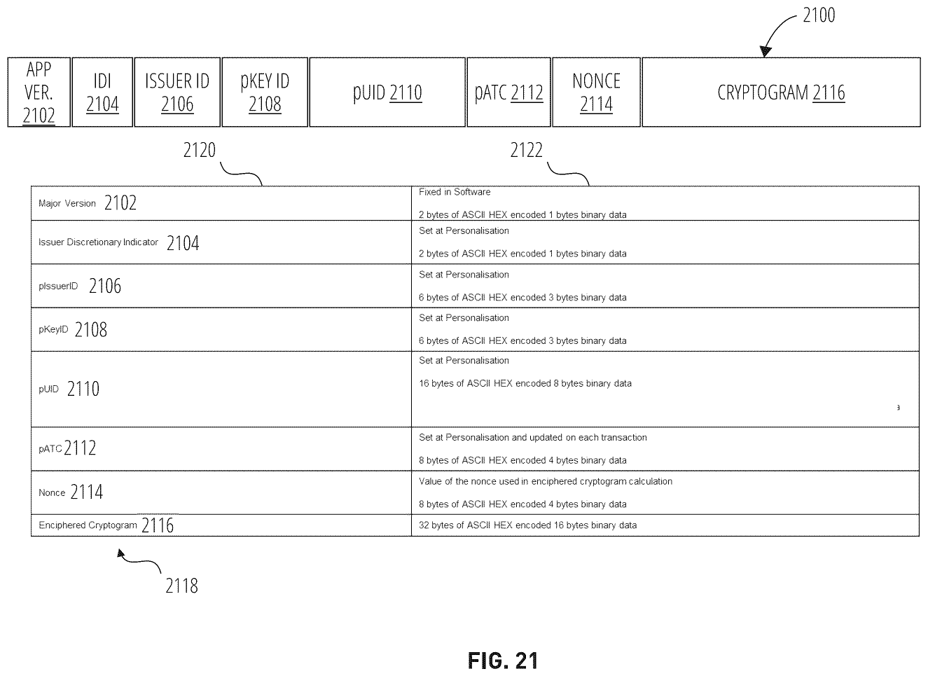

FIG. 18 illustrates an example flow 1800 that may be performed by a contactless card or circuitry thereon to generate a cryptogram to perform operations discussed herein, e.g., see FIG. 21, message 2100. The cryptogram C is determined by calculating a MAC over the 32-byte transaction data T using the Authentication Session Key (ASK).

At block 1802, the contactless card including circuitry computes T=[p Version (2 bytes) ∥ pIssuerID (3 bytes) ∥ pKeyID (3 bytes) ∥ pUID (8 bytes) ∥ pATC (4 bytes) ∥ nonce (4 bytes) ∥ pSHSEC (4 bytes) ∥ ‘80’ ∥ ‘00 00 00’]. In one example, the pVersion is an applet version number, the pIssuerID is an issuer identifier, the pKeyID includes data that identifies a set of master keys for a card issuer of the contactless card, the pUID is a card unique identifier assigned to the contactless card, the pATC is a card's counter value, the nonce is the nonce provided during communication with another device as described herein, and the pSHSEC is value to indicate adherence to Secure Hardware Security Evaluation Criteria.

The contactless card may process the data to generate the cryptogram. At block 1804, the contactless card divides T into four blocks of 8 bytes of data: T=T1 ∥ T2 ∥ T3 ∥ T4. At block 1806, the contactless card computes B=DES (ASKL) [T1], where is the Data Encryption Standard or another symmetric encryption algorithm, ASKL is a portion of the ASK, e.g., the “left” half of the key. At block 1808, the contactless card computes B=[B XOR T2], and at block 1810, the contactless card computes B=DES (ASKL) [B], where DES is an encryption algorithm. At block 1812, the contactless card computes B=[B XOR T3], and at block 1814, the contactless card computes B=DES (ASKL) [B]. At block 1816, the contactless card computes B=[B XOR T4] and at block 1818 the contactless card computes B=DES (ASKL) [B]. At block 1820, the contactless card compute B=DES-1 (ASKR) [B], where DES-1 is the reciprocal DES operation and ASKR is a portion of the ASK, e.g., the right half. At block 1822, the contactless card computes the cryptogram C=DES (ASKL) [B].

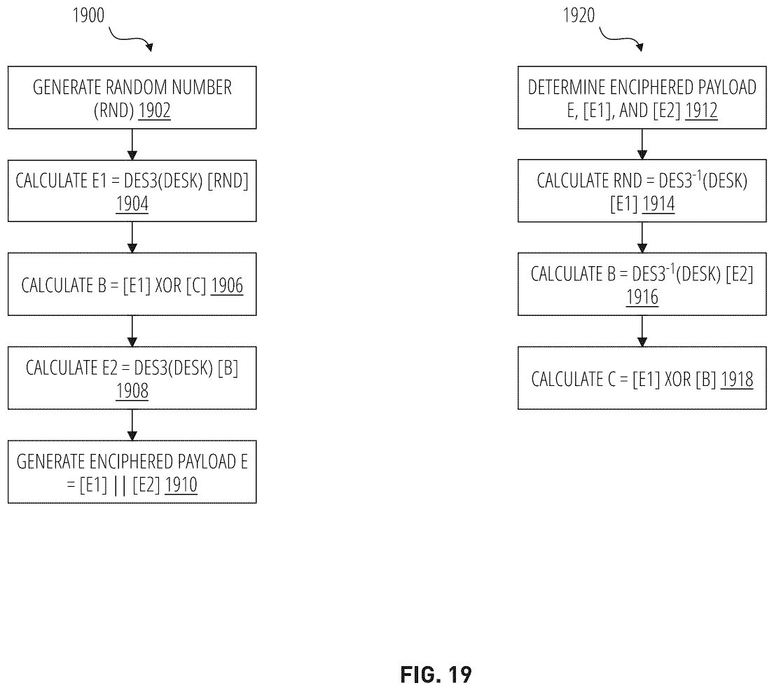

In embodiments, a contactless card may encipher the cryptogram to secure the data further. FIG. 19 illustrates an example flow 1900 to encipher the cryptogram with the Data Encipherment Session Key (DESK) (FIG. 17, flow 1708) being used to encrypt in Cipher Block Chaining mode (CBC).

At block 1902, a contactless card including circuitry is configured to generate an 8-byte random number [RND]. At block 1904, the contactless card computes E1=DES3 (DESK) [RND], where DES3 is a symmetric encryption algorithm such as the Triple Data Encryption Standard. At block 1906, the contactless card computes B=[E1] XOR [C], where C is the cryptogram generated in flow 1800. The contactless card computes E2=DES3 (DESK) [B] at block 1908, where B is computed above in FIG. 18, flow 1800. At block 1910 the contactless card generates the 16-byte enciphered payload E=[E1] ∥ [E2].

In embodiments, a device or the contactless card my decrypt the payload E in accordance with flow 1920. At block 1912, a device determines or retrieves the payload E. At block 1914, the device computes a RND=DES3⁻¹ (DESK) [E1]. At block 1916, the device determines B=DES3⁻¹ (DESK) [E2], and at block 1918, the device computes C=[E1] XOR [B].

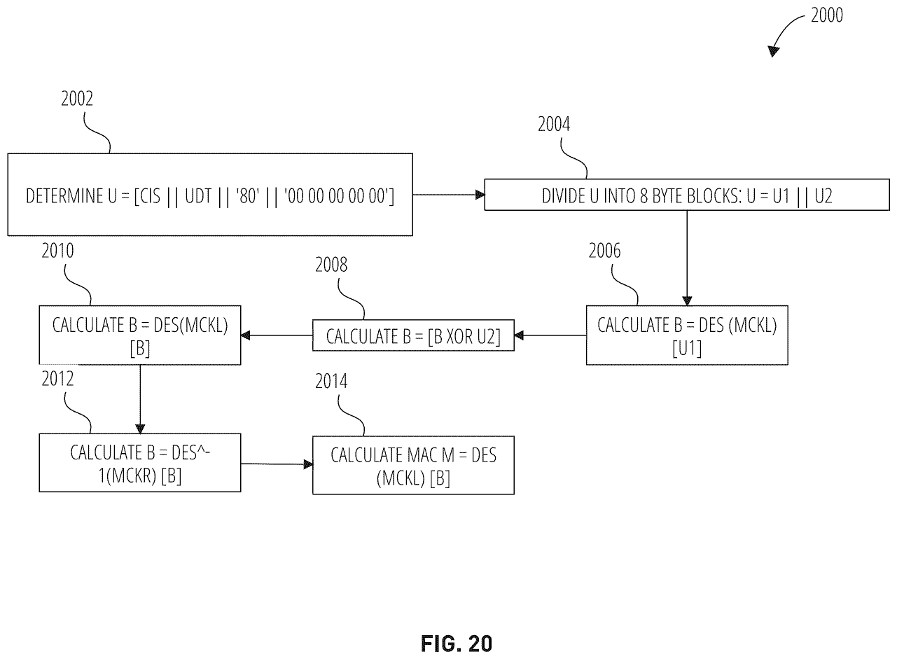

FIG. 20 illustrates an example flow 2000 for calculate a message authentication code (MAC). The operations of flow 2000 by circuitry of the contactless card. In some instances, the MAC may be an updated MAC. In embodiments, the updated MAC is included in data communicated from a contactless card to another device, such as a mobile device, point-of-sale (POS) terminal, or any other type of computer. In one example, the update MAC may be included in an NDEF message.

In embodiments, the updated MAC may be calculated to protect the control indicators and include updated date/time. For example, the update MAC M is determined by calculating a MAC over the 10 bytes of the update data U with the Update MAC Card Key (MCK) as follows.

At block 2002, embodiments include determining data to process through a number of calculations and computations. In one example, the data U equals the [Control Indicators (2 bytes) ∥ Update Date Time (8 bytes) ∥ ‘80’ ∥ ‘00 00 00 00 00’]. For the calculations, the data may be divided into two separate portions. Specifically, at block 2004, data U is broken into two blocks of 8 bytes of data, where U=U₁ ∥ U₂. Further, operations may be performed on U₁ and U₂.

At block 2006 embodiments include applying an algorithm to the first portion (U₁) of the data. In one example, a result B may be computed where B=DES (MCKL) [U₁], where DES is a Data Encryption Standard algorithm using a first portion (L) of the MAC Card Key (MCKL).

At block 2008 an additional operation may be performed on the result B. Specifically, the result B may be exclusively or'd (XOR) with a second portion of the data (U₂).

The updated result B may be further processed at block 2010. For example, result B may be further processed by applying the DES algorithm using MCKL again to B. The result B of block 2010 may further be processed at block 2012. Specifically, the result B may be processed by the inverse DES with a second portion (R) of the MCK (MCKR). And at block 2014, the MAC M may be determined by applying the DES algorithm with the MCKL to result B of block 2012.

FIG. 21 illustrates an example of a message 2100 that may be communicated by a contactless card to perform the functions described herein. One or more of the fields in message 2100 may also be utilized to route the message 2100 through the switchboard system and perform authentication/validation techniques.

In embodiments, the message 2100 includes an applet version 2102 field, an issuer discretionary indicator 2104 field, an Issuer Identifier 2106 field, a pKey ID 2108 field, a pUID 2110 field, a pATC 2112 field, a nonce 2114 field, and an encrypted cryptogram 2116.

In embodiments, the fields may be in plain text or encrypted. For example, the applet version 2102 field may include an applet version in plain text. The applet version to indicate which applet version is installed on a contactless card and may be used by the other systems to determine how to process the message 2100 when communicated. For example, different Applet versions require different validation logic, e.g., an older message may be routed through the issuer system to perform various operations for validation, while a newer message may be routed through the switchboard system to perform the various operations, including validation.

In embodiments, the message 2100 includes an issuer discretionary indicator 2104 field that may include issuer data and set at the time of personalization. In addition, the message 2100 includes an Issuer Identifier 2106 field that may include a unique ID assigned to the entity issuing the card, e.g., the issuer. For example, each issuer may be assigned a unique identifier during an onboarding operation when joining the system. The issuer ID can be used by the switchboard system 1508 to route a message and its contents to the appropriate services that are associated with that particular issuer.

In embodiments, the message 2100 includes a pKey ID 2108 field. In some instances, the pKey ID 2108 field may include data that identifies a set of master keys for a card issuer. The issuer's set of master keys may utilize each cards set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's masters keys to regenerate session keys by the system to perform a validation.

In embodiments, each contactless card 108 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described in FIG. 16, flow 1600.

The message 2100 may include a pUID 2110 field, including a card unique identifier assigned to the contactless card at personalization time. The pUID 2110 field data may be a combination of alphanumeric characters used to uniquely identify each card and associated with a user.

In embodiments, the message 2100 includes a pATC 2112 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 2100 is created, a new session key is derived and utilized to generate one or more portions of the message 2100. Specifically, a session key is used to calculate the cryptographic MAC (Application Cryptogram). The card's applet supports a session key derivation option to generate a unique cryptogram session key ASK as discussed in FIG. 17, flow 1700 and unique encipherment session key (DESK) as discussed in flow 1708. The generation of the cryptogram is discussed in flow 1700 and flow 1900. Further the cryptogram may be decrypted in accordance with flow block 1908.

In embodiments, a portion of the data provided in message 2100 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 108 may communicate a message between a device, such as a mobile device, during a read operation. For example, in response to the contactless card 108 being tapped onto a surface of the device, e.g., brought within wireless communication range, a read operation may be performed on the contactless card 108, and the contactless card 108 may generate and provide the message to the device. For example, once within range, the contactless card 108 and the device may perform one or more exchanges for the contactless card 108 to send the message to the device.

The wireless communication may be in accordance with a wireless protocol, such as near-field communication (NFC), Bluetooth, WiFi, and the like. In some instances, a message may be communicated between a contactless card 1502 and a device via wired means, e.g., via the contact pad 808, and in accordance with the EMV protocol.

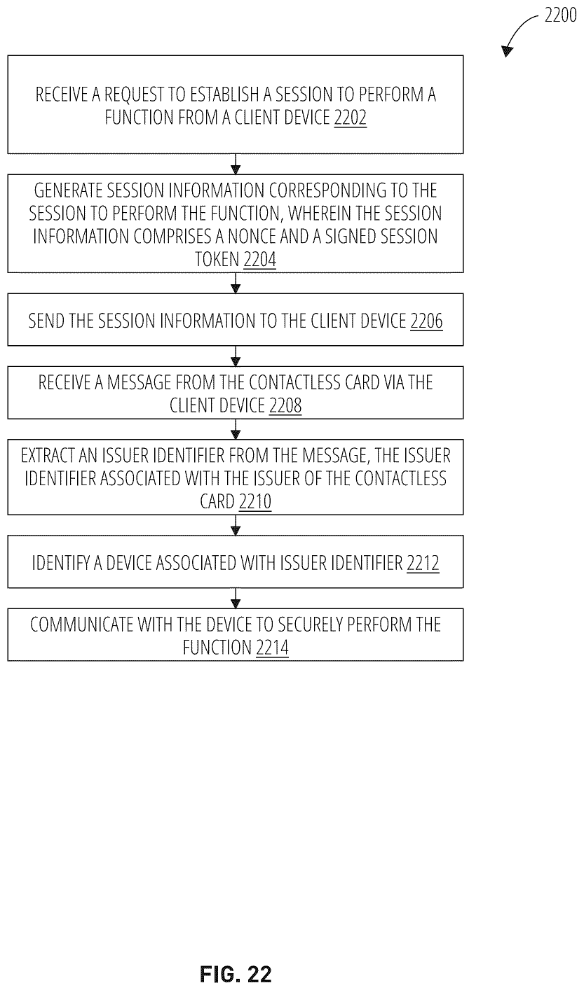

FIG. 22 illustrates an example of routine 2200 in accordance with embodiments discussed herein. In block 2202, the routine 2200 includes receiving, by a node in a system, a request to establish a session to perform a function from a client device, wherein the function is at least partially performed utilizing a contactless card. In some instances, the node may be one of a plurality nodes of a switchboard system. The node may be previously selected by the sending device via a DNS operation performed.

In block 2204, the routine 2200 includes generating, by the node, session information corresponding to the session to perform the function, wherein the session information comprises a nonce and a signed session token. The nonce and/or signed session token may be utilized by systems to perform the functions described herein while ensuring the node routing the data is authenticate, the message from the contactless card is authenticate, and to keep track of the session for the function.

In block 2206, routine 2200 includes sending, by the node, the session information to the client device. The client device may communicate with a contactless card to receive data from the card to authenticate and perform a function. In some instances, the client device may send the nonce from the node to the contactless card. The contactless card may utilize the nonce when generating the message to communicate back to the client device and finally, the node, e.g., incorporates it into a cryptographic portion of the message (as shown in FIG. 21).

In block 2208, routine 2200 includes receiving, by the node, a message from the contactless card via the client device. The message may be generated by the contactless card. FIG. 21 illustrates one example of a message 2100. In some embodiments, the node verifies the message. For example, the node may verify a nonce in the message and a signed session token.

In block 2210, routine 2200 extracts, by the node, an issuer identifier from the message, the issuer identifier associated with the issuer of the contactless card. In some instances, the issuer identifier may be in a plaintext format.

In block 2212, routine 2200 identifies, by the node, a device associated with the issuer identifier. For example, the node may perform a lookup to determine a server associated with the issuer identifier and the function to be performed.

In block 2214, routine 2200 communicates, by the node, with the device to securely perform the function.

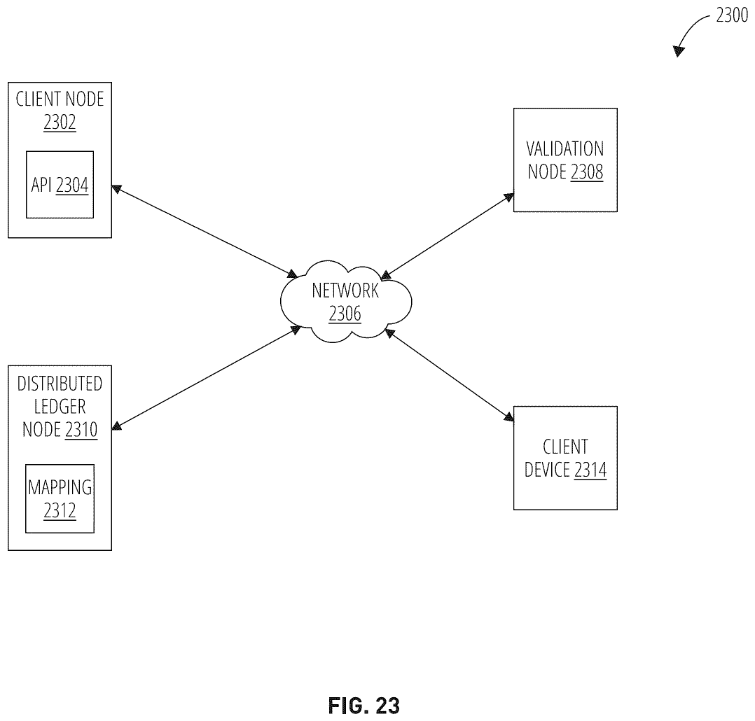

FIG. 23 illustrates a distributed network authentication system 1100 according to an example embodiment. As further discussed below, system 1100 can include client node 2302, API 2304, network 2306, distributed ledger node 2310, mapping 2312, and client device 2314. Although FIG. 23 illustrates single instances of the components, system 1100 can include any number of components.

System 1100 can include a client node 2302, which can be a network-enabled computer as described herein. In some examples, client node 2302 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, client node 2302 can execute one or more applications, such as software applications, that enable, for example, network communications with one or more components of system 1100, transmit and/or receive data, and perform the functions and processes described herein.

The client node can contain an API 2304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 2304 to interact with the service, such as by performing a remote call to an API for interacting with a web-based service.

API 2304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 2302 can communicate with one or more other components of system 1100 either directly or via network 2306. Network 2306 can comprise one or more of a wireless network, a wired network or any combination of wireless network and wired network, and may be configured to connect the components of system 1100. While FIG. 23 illustrates communication between the components of system 1100 through network 2306, it is understood that any component of system 1100 can communicate directly with another component of system 1100, e.g., without involving network 2306.

System 1100 can include a validation node 2308, which can be a network-enabled computer as described herein. In some examples, validation node 2308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, validation node 2308 can execute one or more applications, such as software applications, that enable, for example, network communications with one or more components of system 1100, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1100 can include a distributed ledger node 2310, which can be a network-enabled computer as described herein. In some examples, distributed ledger node 2310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100.

In some examples, distributed ledger node 2310 can execute one or more applications, such as software applications, that enable, for example, network communications with one or more components of system 1100, transmit and/or receive data, and perform the functions and processes described herein.

Distributed ledger node 2310 can containing a mapping 2312. In some examples, mapping 2312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1100, or the one or more databases can be hosted externally to any component of the system 1100. In some examples, the one or more databases can be contained in the distributed ledger node 2310, and in other examples the one or more databases can be stored outside of distributed edger node 2310 but in data communication with distributed ledger node 2310. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 2310. In other examples, the one or more databases can be remote from distributed ledger node 2310 but in data communication with distributed ledger node 2310. Data communication between the one or more databases and distributed ledger node 2310 can be a direct data communication or data communication via a network, such as the network 2306.

In some examples, client node 2302 can be in data communication with distributed ledger node 2310. Distributed ledger node 2310 can contain mapping 2312. Mapping 2314 may include, e.g., a mapping between a validation node address and the validation node 2308, a mapping between a routing number and a validation node address, and/or a mapping between a routing number and validation node 2308. In some examples, mapping 2312 can include a digital signature associated with an entity having permission to validate for a routing number. Based on one or more of these associations, client node 2302 can call validation node for validation and/or provide direction to the client device to reach the appropriate validation node. This can be accomplished by calling a validation API associated with validation node 2308.

In some examples, iterations of the mappings described herein, such as mapping 2312, can also include a software or applet version number. The version number can be used to identify a validation node or validation node address or choose between multiple validation addresses for one validation node.

In some examples, client node 2302 and distributed ledger node 2310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 2310 can update mapping 2312 to reflect a different association between, e.g., a routing number, a validation node address, and a validation node. In some examples, degrees of permissions can be issued. For example, if client node 2302 were to function to route data to validation node 2308 (or other validation nodes), client node 2302 can be given a certain level of permissions. As another example, if distributed ledger node 2310 were to have the capability to update mapping 2312, distributed ledger node 2310 can have a different, higher level of permissions.

System 1100 can include a client device 2314, which can be a network-enabled computer as described herein. In some examples, distributed ledger node 2314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1100. Client device 2314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 2314 can be in data communication with another network-enabled computer not shown in FIG. 23, such as a smart card (e.g., a contactless card or a contact-based card).

In some examples, client device 2314 can execute one or more applications, such as software applications, that enable, for example, network communications with one or more components of system 1100, transmit and/or receive data, and perform the functions and processes described herein.

In some examples, upon receipt of an authentication request, client device 2314 can call (e.g., via an API) client node 2302. The call can include a routing number and/or an applet or software version number, and client node 2302 can query distributed ledger node 2310 and mapping 2312. Once the query returns the identification of a validation node (e.g., validation node 2308) and/or a validation node address associated with that routing number and/or applet or software version, client node 2302 can reply to client device 2314. Client device 2314 can then proceed with authentication with the validation node. The authentication can be performed by, e.g., the systems and methods described herein, such as by the generation, encryption, transmission, decryption, and validation of a cryptogram as described herein.

In some examples, client node 2302 can be co-resident with validation node 2308. In these examples, client node 2302 can handle the authentication in a single call from client device 2314. In some examples, this can be acceptable only if it is permissible for the full authentication transmission (e.g., a cryptogram as described herein) to be sent to client nodes that are not involved in authentication.

In some examples, if client node 2302 receives, from client device 2314, a routing number that is not handled by its location, client node 2302 can return a code indicating that this routing number is not handled, along with validation node address for the responsible validation node. Client device 2314 can then send the full authentication transmission to validation node 2308 using the received validation node address.

In some examples, client node 2302 can enter the distributed network with different permissions. For example, client node 2302 can be a read-only router of data. As another example, client node 2302 can have permission to send messages to distributed ledger node 2310 updating one or more routing paths for one or more routing numbers. However, client node 2302 would be prevented from updating one or more routing paths for one or more routing numbers for other entities that control other routing numbers which are not associated with client node 2302 or that did not grant this permission. As another example, distributed ledger node 2310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 2302, distributed ledger node 2310, and/or validation node 2308, if security, legal, and/or financial conditions are met, however, delegation is not required.

In some examples, one or more APIs can facilitate communication between components of system 1100 via network 2306. In other examples, one or more APIs are not required. Rather, the components of system 1100 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 2308 for authentication, can require storage of the keys in one or more HSMs, to promote key security and ensure that the keys are never entered into memory.

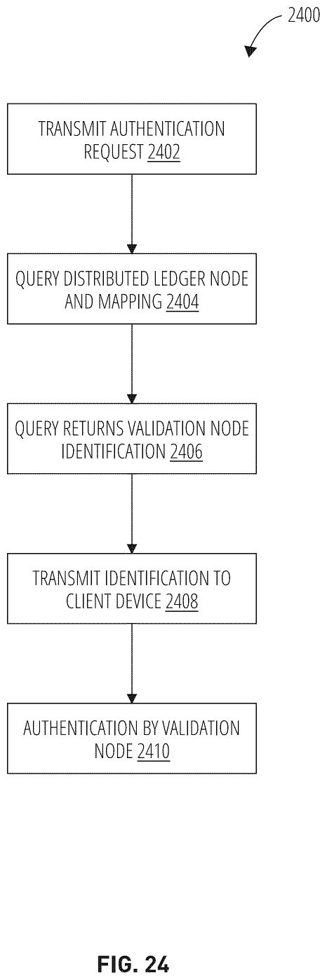

FIG. 24 illustrates a method 2400 performed by a distributed network authentication system according to an example embodiment. For example, the method can be performed by distributed network authentication system 2300 and or by another distributed network authentication system.

In block 2402, a client device can transmit an authentication request to a client node. The authentication request can include, without limitation, a routing number, a software version number, and/or an applet version number. The request can be made by an API call or other communication between the client device and the client node.

In block 2404, after receiving the authentication request, the client node can transmit a query (e.g., via an API call) to a distributed ledger node. The distributed ledger node contain a mapping, and the distributed ledger node can submit the query to the mapping.

In block 2406, the query can return an identification of a validation node and/or a validation node address, and the distributed ledger node can transmit this identification to the client node.

In block 2408, the client node can transmit the identification to the client device. After receiving the identification, the client device can proceed with authentication with the identified validation node and/or validation node address, in block 2410.

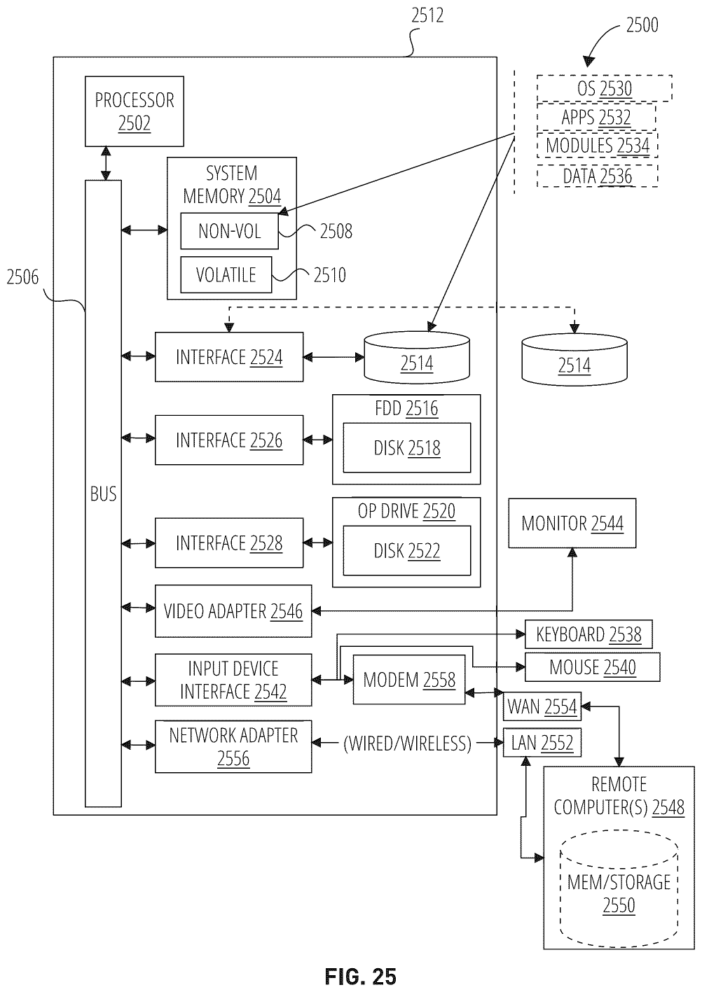

FIG. 25 illustrates an embodiment of an exemplary computer architecture 2500 suitable for implementing various embodiments as previously described. In one embodiment, the computer architecture 2500 may include or be implemented as part of computing architecture 100. For example, the computer architecture 2500 or parts of it can be used to implement the computing devices 102, 304, 210, the contactless card 108, 302, etc. In some cases, for example, in the case of the contactless card 108, some of the components described herein may not be included.

As used in this application, the terms “system” and “component” are intended to refer to a computer-related entity, either hardware, a combination of hardware and software, software, or software in execution, examples of which are provided by the exemplary computing computer architecture 2500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 2500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 2500.

As shown in FIG. 25, the computer architecture 2500 includes a computer 2512 comprising a processor 2502, a system memory 2504 and a system bus 2506. The processor 2502 can be any of various commercially available processors. The computer 2512 may be representative of the computing devices 102, 304, 210.

The system bus 2506 provides an interface for system components including, but not limited to, the system memory 2504 to the processor 2502. The system bus 2506 can be any of several types of bus structure that may further interconnect to a memory bus (with or without a memory controller), a peripheral bus, and a local bus using any of a variety of commercially available bus architectures. Interface adapters may connect to the system bus 2506 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 2500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 25, the system memory 2504 can include non-volatile 2508 and/or volatile 2510. A basic input/output system (BIOS) can be stored in the non-volatile 2508.

The computer 2512 may include various types of computer-readable storage media in the form of one or more lower speed memory units, including an internal (or external) hard disk drive 2514, a magnetic disk drive 2516 to read from or write to a removable magnetic disk 2518, and an optical disk drive 2520 to read from or write to a removable optical disk 2522 (e.g., a CD-ROM or DVD). The hard disk drive 2514, magnetic disk drive 2516 and optical disk drive 2520 can be connected to the system bus 2506 by an HDD interface 2524, and FDD interface 2526 and an optical disk drive interface 2528, respectively. The HDD interface 2524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 2508, and volatile 2510, including an operating system 2530, one or more applications 2532, other program modules 2534, and program data 2536. In one embodiment, the one or more applications 2532, other program modules 2534, and program data 2536 can include, for example, the various applications and/or components of the system 100.

A user can enter commands and information into the computer 2512 through one or more wire/wireless input devices, for example, a keyboard 2538 and a pointing device, such as a mouse 2540. Other input devices may include microphones, infra-red (IR) remote controls, radiofrequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, track pads, sensors, styluses, and the like. These and other input devices are often connected to the processor 2502 through an input device interface 2542 that is coupled to the system bus 2506 but can be connected by other interfaces such as a parallel port, IEEE 1394 serial port, a game port, a USB port, an IR interface, and so forth.

A monitor 2544 or other type of display device is also connected to the system bus 2506 via an interface, such as a video adapter 2546. The monitor 2544 may be internal or external to the computer 2512. In addition to the monitor 2544, a computer typically includes other peripheral output devices, such as speakers, printers, and so forth.

The computer 2512 may operate in a networked environment using logical connections via wire and/or wireless communications to one or more remote computers, such as a remote computer(s) 2548. The remote computer(s) 2548 can be a workstation, a server computer, a router, a personal computer, portable computer, microprocessor-based entertainment appliance, a peer device or other common network node, and typically includes many or all the elements described relative to the computer 2512, although, for purposes of brevity, only a memory and/or storage device 2550 is illustrated. The logical connections depicted include wire/wireless connectivity to a local area network 2552 and/or larger networks, for example, a wide area network 2554. Such LAN and WAN networking environments are commonplace in offices and companies, and facilitate enterprise-wide computer networks, such as intranets, all of which may connect to a global communications network, for example, the Internet.

When used in a local area network 2552 networking environment, the computer 2512 is connected to the local area network 2552 through a wire and/or wireless communication network interface or network adapter 2556. The network adapter 2556 can facilitate wire and/or wireless communications to the local area network 2552, which may also include a wireless access point disposed thereon for communicating with the wireless functionality of the network adapter 2556.

When used in a wide area network 2554 networking environment, the computer 2512 can include a modem 2558, or is connected to a communications server on the wide area network 2554 or has other means for establishing communications over the wide area network 2554, such as by way of the Internet. The modem 2558, which can be internal or external and a wire and/or wireless device, connects to the system bus 2506 via the input device interface 2542. In a networked environment, program modules depicted relative to the computer 2512, or portions thereof, can be stored in the remote memory and/or storage device 2550. It will be appreciated that the network connections shown are exemplary and other means of establishing a communications link between the computers can be used.

The computer 2512 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

In one aspect a computer-implemented method may include detecting, using at least one processor of an audio signal receiving device, a first device and establishing a near-field communication (NFC) exchange communication link with the first device; receiving, using the at least one processor of the audio signal receiving device, one or more signals from the first device, each of the one or more signals being responsive to one or more transmissions generated and sent to the first device by a transceiver coil of the audio signal receiving device, the transceiver coil being coupled to the at least one processor; determining, using the at least one processor of the audio signal receiving device, a signal strength of the one or more signals from the first device, and, based on the determined signal strength, determining a first position of the first device in relation to the audio signal receiving device; generating, using the at least one processor of the audio signal receiving device, one or more prompts to reposition the first device in relation to the audio signal receiving device from the first position to one or more second positions, at least one second position in the one or more second positions corresponding to a maximum signal strength of the one or more signals; and extracting, using the at least one processor of the audio signal receiving device, information from the first device upon the first device being in the at least one second position.

The method may also include wherein the audio signal receiving device includes at least one of: one or more earphones, one or more headphones, one or more virtual reality devices, one or more augmented reality devices, one or more virtual reality glasses, one or more augmented reality glasses, and any combinations thereof.

The method may also include wherein the first device is a contactless card.

The method may also include wherein the contactless card, based on the establishing of the NFC exchange communication link, is configured to transmit to the audio signal receiving device a contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

The method may also include wherein the contactless card includes at least one of the following: a credit card, a debit card, an electronic gift card, a pre-paid credit card, a pre-paid debit card, and any combination thereof.

The method may also include wherein the signal strength is determined based on a current load measured at the transceiver coil.

The method may also include wherein the maximum signal strength corresponds to a maximum current load measured at the transceiver coil.

The method may also include wherein a content of at least one prompt in the one or more prompts is different from at least another prompt in the one or more prompts and is determined based on the determined signal strength.

The method may also include wherein the content of the at least one prompt includes at least one of: an audio prompt, a video prompt, a graphics prompt, an image prompt, a textual prompt, and any combinations thereof.

In one aspect, a system may include at least one processor; and at least one non-transitory storage media storing instructions, that when executed by the at least one processor, cause the at least one processor to: determine a signal strength of one or more signals received from a first device, and, based on the determined signal strength, determine a first position of the first device; generate one or more prompts to reposition the first device from the first position to one or more second positions, at least one second position in the one or more second positions corresponding to a maximum signal strength of the one or more signals; and extract information from the first device upon the first device being in the at least one second position.

The system may also include wherein each of the one or more signals is responsive to one or more transmissions generated and sent to the first device by a transceiver coil coupled to the at least one processor.

The system may also include wherein an audio signal receiving device includes the at least one processor and the at least one non-transitory storage media, wherein the audio signal receiving device includes at least one of: one or more earphones, one or more headphones, one or more virtual reality devices, one or more augmented reality devices, one or more virtual reality glasses, one or more augmented reality glasses, and any combinations thereof.

The system may also include wherein the at least one processor is configured to detect the first device and establish a near-field communication (NFC) exchange communication link with the first device.

The system may also include wherein the first device is a contactless card.

The system may also include wherein the contactless card, based on the establishing of the NFC exchange communication link, is configured to transmit to the audio signal receiving device a contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

The system may also include wherein the contactless card includes at least one of the following: a credit card, a debit card, an electronic gift card, a pre-paid credit card, a pre-paid debit card, and any combination thereof.

The system may also include wherein the signal strength is determined based on a current load measured at the transceiver coil, wherein the maximum signal strength corresponds to a maximum current load measured at the transceiver coil.

The system may also include wherein a content of at least one prompt in the one or more prompts is different from at least another prompt in the one or more prompts and is determined based on the determined signal strength.

The system may also include wherein the content of the at least one prompt includes at least one of: an audio prompt, a video prompt, a graphics prompt, an image prompt, a textual prompt, and any combinations thereof.

In one aspect, a computer program product comprising a non-transitory machine-readable medium storing instructions that, when executed by at least one programmable processor, may cause the at least one programmable processor to: determine a signal strength of one or more signals received from a first device, and, based on the determined signal strength, determine a first position of the first device; generate one or more prompts to reposition the first device from the first position to one or more second positions, at least one second position in the one or more second positions corresponding to a maximum signal strength of the one or more signals, wherein the maximum signal strength corresponds to a maximum current load measured at the transceiver coil, wherein a content of at least one prompt in the one or more prompts is different from at least another prompt in the one or more prompts and is determined based on the determined signal strength; and extract information from the first device upon the first device being in the at least one second position.

In one aspect a computer-implemented method may include receiving, using at least one processor of an audio signal receiving device, one or more first signals from a first device via a first wireless communication link communicatively coupling the audio signal receiving device and the first device; converting, using the at least one processor of the audio signal receiving device, the one or more first signals to one or more second signals; and transmitting, using the at least one processor of the audio signal receiving device, the one or more second signals to a mobile device via a second wireless communication link communicatively coupling the audio signal receiving device and the mobile device, the first wireless communication link being different from the first wireless communication link, wherein, upon receiving the one or more second signals, the mobile device is configured to generate one or more graphical user interfaces based on the one or more second signals.

The method may also include wherein the first device is a contactless card.

The method may also include wherein the first wireless communication link is a near-field communication (NFC) exchange communication link, and the second wireless communication link is a Bluetooth communication link.

The method may also include wherein the one or more first signals include one or more first data packets storing information associated with the contactless card.

The method may also include wherein the converting includes extracting the information associated with the contactless card from the one or more first data packets; generating, using the extracted information associated with the contactless card, one or more second data packets; and generating, using the one or more second data packets, the one or more second signals for transmission to the mobile device.

The method may also include wherein the one or more graphical user interfaces display the information associated with the contactless card.

The method may also include wherein the information associated with the contactless card includes contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

The method may also include wherein the contactless card includes at least one of the following: a credit card, a debit card, an electronic gift card, a pre-paid credit card, a pre-paid debit card, and any combination thereof.

The method may also include wherein the audio signal receiving device includes at least one of: one or more earphones, one or more headphones, one or more virtual reality devices, one or more augmented reality devices, one or more virtual reality glasses, one or more augmented reality glasses, and any combinations thereof.

In one aspect, a system may include at least one processor; and at least one non-transitory storage media storing instructions, that when executed by the at least one processor, cause the at least one processor to: convert one or more first signals received from a first device via a first wireless communication link to one or more second signals; and transmit the one or more second signals to a mobile device via a second wireless communication link communicatively, the first wireless communication link is different from the second wireless communication link, wherein, upon receiving the one or more second signals, the mobile device is configured to generate one or more graphical user interfaces based on the one or more second signals.

The system may also include wherein the first device is a contactless card.

The system may also include wherein the first wireless communication link is a near-field communication (NFC) exchange communication link, and the second wireless communication link is a Bluetooth communication link.

The system may also include wherein the one or more first signals include one or more first data packets storing information associated with the contactless card.

The system may also include wherein the converting includes extracting the information associated with the contactless card from the one or more first data packets; generating, using the extracted information associated with the contactless card, one or more second data packets; and generating, using the one or more second data packets, the one or more second signals for transmission to the mobile device.

The system may also include wherein the one or more graphical user interfaces display the information associated with the contactless card.

The system may also include wherein the information associated with the contactless card includes contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

The system may also include wherein the contactless card includes at least one of the following: a credit card, a debit card, an electronic gift card, a pre-paid credit card, a pre-paid debit card, and any combination thereof.

The system may also include wherein an audio signal receiving device includes the at least one processor and the at least one non-transitory storage media, where the audio signal receiving device includes at least one of: one or more earphones, one or more headphones, one or more virtual reality devices, one or more augmented reality devices, one or more virtual reality glasses, one or more augmented reality glasses, and any combinations thereof.

In one aspect, a computer program product comprising a non-transitory machine-readable medium storing instructions that, when executed by at least one programmable processor, cause the at least one programmable processor to: convert one or more first signals received from a contactless card via a first wireless communication link to one or more second signals, wherein conversion of the one or more first signals includes extracting information associated with the contactless card from one or more first data packets included in the one or more first signals; generating, using the extracted information associated with the contactless card, one or more second data packets; and generating, using the one or more second data packets, the one or more second signals for transmission to the mobile device; and transmit the one or more second signals to a mobile device via a second wireless communication link communicatively, the first wireless communication link being different from the first wireless communication link, wherein, upon receiving the one or more second signals, the mobile device is configured to generate one or more graphical user interfaces based on the one or more second signals.

The computer program product may also include wherein the one or more graphical user interfaces display the information associated with the contactless card.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1. A computer-implemented method, comprising:
detecting, using at least one processor of an audio signal receiving device, a first device and establishing a near-field communication (NFC) exchange communication link with the first device;
receiving, using the at least one processor of the audio signal receiving device, one or more signals from the first device, each of the one or more signals being responsive to one or more transmissions generated and sent to the first device by a transceiver coil of the audio signal receiving device, the transceiver coil being coupled to the at least one processor;
determining, using the at least one processor of the audio signal receiving device, a signal strength of the one or more signals from the first device, and, based on the determined signal strength, determining a first position of the first device in relation to the audio signal receiving device;
generating, using the at least one processor of the audio signal receiving device, one or more prompts to reposition the first device in relation to the audio signal receiving device from the first position to one or more second positions, at least one second position in the one or more second positions corresponding to a maximum signal strength of the one or more signals; and
extracting, using the at least one processor of the audio signal receiving device, information from the first device upon the first device being in the at least one second position.

2. The method of claim 1, wherein the audio signal receiving device includes at least one of: one or more earphones, one or more headphones, one or more virtual reality devices, one or more augmented reality devices, one or more virtual reality glasses, one or more augmented reality glasses, and any combinations thereof.

3. The method of claim 1, wherein the first device is a contactless card.

4. The method of claim 3, wherein the contactless card, based on the establishing of the NFC exchange communication link, is configured to transmit to the audio signal receiving device a contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

5. The method of claim 4, wherein the contactless card includes at least one of the following: a credit card, a debit card, an electronic gift card, a pre-paid credit card, a pre-paid debit card, and any combination thereof.

6. The method of claim 1, wherein the signal strength is determined based on a current load measured at the transceiver coil.

7. The method of claim 6, wherein the maximum signal strength corresponds to a maximum current load measured at the transceiver coil.

8. The method of claim 1, wherein a content of at least one prompt in the one or more prompts is different from at least another prompt in the one or more prompts and is determined based on the determined signal strength.

9. The method of claim 8, wherein the content of the at least one prompt includes at least one of: an audio prompt, a video prompt, a graphics prompt, an image prompt, a textual prompt, and any combinations thereof.

10. A computer-implemented method, comprising:
receiving, using at least one processor of an audio signal receiving device, one or more first signals from a first device via a first wireless communication link communicatively coupling the audio signal receiving device and the first device;
converting, using the at least one processor of the audio signal receiving device, the one or more first signals to one or more second signals; and
transmitting, using the at least one processor of the audio signal receiving device, the one or more second signals to a computing device via a second wireless communication link communicatively coupling the audio signal receiving device and the computing device, the first wireless communication link is different from the second wireless communication link, wherein, upon receiving the one or more second signals, the computing device is configured to generate one or more graphical user interfaces based on the one or more second signals.

11. The method of claim 10, wherein the first device is a contactless card.

12. The method of claim 11, wherein the first wireless communication link is a near-field communication (NFC) exchange communication link, and the second wireless communication link is a Bluetooth communication link.

13. The method of claim 12, wherein the one or more first signals include one or more first data packets storing information associated with the contactless card.

14. The method of claim 13, wherein the converting includes extracting the information associated with the contactless card from the one or more first data packets;
generating, using the extracted information associated with the contactless card, one or more second data packets; and
generating, using the one or more second data packets, the one or more second signals for transmission to the computing device.

15. The method of claim 14, wherein the one or more graphical user interfaces display the information associated with the contactless card.

16. The method of claim 13, wherein the information associated with the contactless card includes contactless card data, the contactless card data includes at least one of the following: an account number associated with the contactless card, a virtual account number associated with the contactless card, an expiration date associated with the contactless card, a card verification value (CVV) associated with the contactless card, a billing address associated with the contactless card, a name of a user associated with the contactless card, and any combination thereof.

17. The method of claim 16, wherein the contactless card includes at least one of the following: a credit card, a debit card, an electronic gift card, a pre-paid credit card, a pre-paid debit card, and any combination thereof.

18. The method of claim 10, wherein the audio signal receiving device includes at least one of: one or more earphones, one or more headphones, one or more virtual reality devices, one or more augmented reality devices, one or more virtual reality glasses, one or more augmented reality glasses, and any combinations thereof.
